(19) United States
(12) Patent Application Publication
(10) Pub. No.: US 2024/0382886 A1
(43) Pub. Date: Nov. 21, 2024

(54) MORPHOLOGICALLY ENHANCED, ADSORBENT FILTER MEDIA

(71) Applicant: Hollingsworth & Vose Company, East Walpole, MA (US)

(72) Inventors: Sudheer Jinka, Pelham, NH (US); Praveen Kumar Yegya Raman, Ayer, MA (US); James M. Witsch, Westfield, MA (US)

(73) Assignee: Hollingsworth & Vose Company, East Walpole, MA (US)

(21) Appl. No.: 18/320,083

(22) Filed: May 18, 2023

(51) Int. Cl. B01D 46/00; B01D 39/16; B01D 39/20

(52) U.S. Cl. CPC B01D 46/0036; B01D 39/1623; B01D 39/2017; B01D 39/2058; B01D 2239/0407; B01D 2239/0618; B01D 2239/0645; B01D 2239/1225; B01D 2239/1291; B01D 2275/10; B01D 2275/20

(57) ABSTRACT

Filter media comprising surface-treated fiber webs having one or more advantageous physical properties are generally described. Certain improvements in the surface-treated fiber webs described herein may be realized in filter media comprising adsorbent particles. The improvements herein are, in some embodiments, related to favorable distributions of cavities in surface-treated fiber webs, such as those used in backers of the filter media.

### TECHNICAL FIELD

The present invention generally relates to filter media, and, more particularly, to filter media comprising fiber webs (e.g., non-woven fiber webs) with improved morphologies.

### BACKGROUND

Filter media may be employed in a variety of applications. For instance, filter media may be employed to remove contaminants from fluids. Some filter media may exhibit undesirable properties such as low dust holding capacities and low filtration efficiencies.

Accordingly, improved filter media designs are needed.

### SUMMARY

Filter media and related methods are described herein.

In one aspect a filter media is provided. According to some embodiments, the filter media comprises: a fiber web comprising a plurality of surface cavities, wherein: the synthetic fibers of the fiber web have an average length of less than or equal to 40 mm, the fiber web has a developed interfacial area ratio greater than or equal to 0.1, and the cavities of the fiber web have an average cross-dimensional frequency of greater than or equal to 3,000 surface cavities per meter; and a plurality of adsorbent particles disposed on the fiber web.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 presents a schematic, cross-sectional illustrations of surface-treated fiber webs comprising pluralities of cavities with different morphologies, according to some embodiments;

FIG. 2 presents a schematic, cross-sectional illustrations of filter media comprising surface-treated fiber web backers and adsorbent particles, according to some embodiments;

FIGS. 3A-3B present schematic, cross-sectional illustrations of filter media comprising surface-treated fiber web backers and additional layers, according to some embodiments;

FIG. 4 presents a cross-sectional measurement of the surface topography of a surface-treated fiber web backer treated for improved cavity morphology, according to some embodiments; and

FIG. 5 presents a cross-sectional measurement of the surface topography of a control surface-treated fiber web backer that was not treated for improved cavity morphology, according to some embodiments.

### DETAILED DESCRIPTION

Filter media comprising fiber webs having advantageous properties are generally described. In some embodiments, a filter media and/or a fiber web described herein is a surface-treated fiber web that comprises a surface morphology that results in enhanced physical properties. For example, a surface-treated fiber web (e.g., belonging to a filter media) may comprise a plurality of cavities formed on a surface of the fiber web and having a favorable size distribution. The cavities may create fiber web surfaces with increased surface area, which may advantageously enhance the dust holding capacity and/or the air permeability of the filter media. The cavities may have a size distribution favorable for the deposition of additional materials, such as particles, onto the fiber web. As described further below, the cavities may be formed in a surface treatment process such as fluid enhancement. In some embodiments, the fiber web functions as a backer on which one or more layers are added to form the filter media. The filter media may be used in a variety of applications including for use in airborne molecular contamination (AMC) removal, fuel cells, cabin air filtration and HVAC filtration.

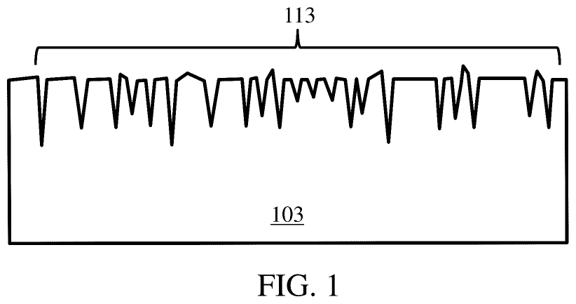

FIG. 1 provided non-limiting, schematic, cross-sectional illustration of a surface morphology of a surface-treated fiber web. As shown in FIG. 1, surface-treated fiber web 103 has a high surface area that results from cavities 113. The surface-treated fiber web may be woven or non-woven. In some embodiments, the use of surface-treated non-woven fiber webs is particularly advantageous for use in filter media. A variety of suitable types of non-woven fiber webs may be employed as surface-treated fiber webs in the filter media described herein. For instance, a filter media may comprise a surface-treated fiber layer comprising a wetlaid non-woven fiber web, a non-wetlaid non-woven fiber web (such as, e.g., an airlaid non-woven fiber web, a carded non-woven fiber web), an electrospun non-woven fiber web, and/or another type of non-woven fiber web.

A morphology such as that of surface-treated fiber web 103 may result from surface treatment (e.g., fluid enhancement) of the surface-treated fiber web. It should be understood that although cavities are only expressly shown on the top surface of the surface-treated fiber web, cavities may be present on one or both sides of a surface-treated fiber web, as the disclosure is not so limited.

Some topographies of cavities have particular advantages for use in filter media. For example, without wishing to be bound by any particular theory, small surface cavities may be associated with uniform distribution of adsorbent particles across a surface of a surface-treated fiber web. Thus, increasing the surface area of a surface-treated fiber web by introducing cavities with favorable morphologies (e.g., by preferentially introducing small and intermediate cavities) may improve filter media performance. Accordingly, the present disclosure is directed, in some embodiments, towards surface-treated fiber webs with favorable cavity morphologies.

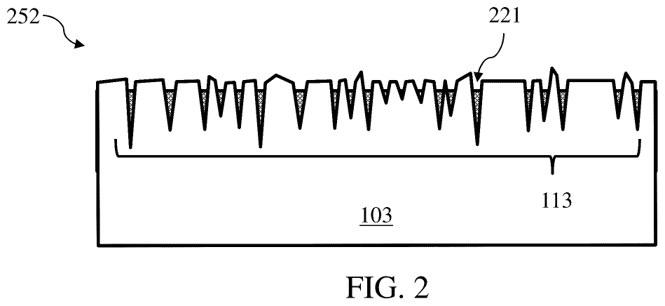

FIG. 2 provides a non-limiting, schematic, cross-sectional illustration of a filter media. Filter media 252, shown in FIG. 2, comprises a surface-treated fiber web 103 and adsorbent particles 221 disposed thereon. As shown in FIG. 2, adsorbent particles may be preferentially disposed within cavities 113 of a surface-treated fiber web.

Consequently, more numerous and/or more uniformly-distributed cavities may be associated with more uniformly-distributed adsorbent particles, which may result in a performance advantage for the filter media. It should, of course, be understood that adsorbent particles need not be confined to the cavities (as shown in FIG. 2), and may instead be deposited on other surfaces of surface-treated fiber webs, as the disclosure is not so limited. For example, adsorbent particles may form a layer on a surface-treated fiber web, in some embodiments. Adsorbent particles are described in greater detail below.

It should, of course, be understood that although the filter media of FIG. 2 is not shown to include additional layers, filter media 252 could comprise additional layers that are omitted from FIG. 2 to improve visual clarity regarding features related to cavities.

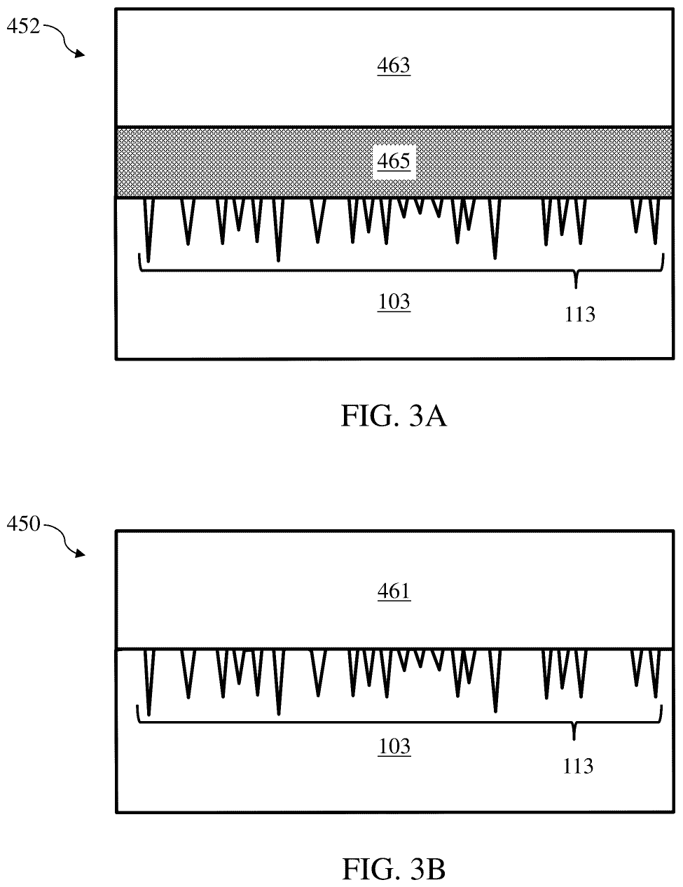

A filter media may comprise one or more additional layers, in addition to a surface layer. FIGS. 3A-3B provide schematic, cross-sectional illustrations of multilayered filter media comprising surface-treated fiber webs and additional layers. FIG. 3A, shows filter media 452 comprising additional layer 463 at least partially disposed on surface-treated fiber web 103 having cavities 113. The filter media has a tri-layered structure, where the additional layer and the surface-treated fiber layer overlap and are separated from one another by layer 465, which may comprise adsorbent particles. FIG. 3B shows filter media 450 comprising additional layer 461 at least partially disposed on surface-treated fiber web 103 having cavities 113. The filter media has a bi-layered structure, and may include additional material (not shown) disposed on one or more of the layers. For example, in some embodiments, the bilayered structure includes a plurality of adsorbent particles disposed between the surface-treated layer and the additional layer. Additional layers may have any of a variety of compositions, and may perform any of a variety of functions within the filter media, as discussed in greater detail below.

As described above, the surface-treated fiber web may comprise a plurality of cavities that has any of a variety of suitable morphologies. Cavities may have any of a variety of appropriate shapes. In some embodiments, for example, the cavity is a pit (e.g., a depression having a relatively small aspect ratio of less than or equal to 10:1, 5:1, or 2:1 between a longest dimension of the cavity and a shortest dimension of the cavity parallel to a surface of a surface-treated fiber web). As another example, in some embodiments, a cavity is a trench (e.g., a depression having a high aspect ratio exceeding 2:1, 5:1, or 10:1 between a longest dimension of the cavity and a shortest dimension of the cavity parallel to a surface of a surface-treated fiber web). Cavities are not limited to any particular depths, shapes, or orientations, as the disclosure is not so limited.

Cavities may have an area exceeding an appropriate cut-off area. For example, the plurality of cavities may be chosen to exclude all cavities with a cutoff area of less than or equal to 20 micrometer², less than or equal to 15 micrometer², less than or equal to 10 micrometer², less than or equal to 5 micrometer², less than or equal to 2 micrometer², less than or equal to 1 micrometer², or less than or equal to 0.05 micrometer².

The area of a cavity may be determined by using a scanning electron microscope (SEM) to image a representative portion (e.g., having an area of at least 10×10 cm²) of a surface-treated fiber web and analyzing the image of the representative portion to identify cavities. The image may be analyzed by setting a white balance of the image to 0 and adjusting the black balance of the image to increase the contrast without obscuring the boundaries between fibers and cavities in the image. Then, the cavities may be individually detected by using a particle-picking software (e.g., the “analyze Particle” tool in ImageJ) to recognize closed and bounded dark areas in the image, corresponding to cavities, and to determine the area of the cavities in the plane of the image. A cavity described herein may have any of a variety of appropriate depths. In some embodiments, a plurality of cavities has an average depth of greater than or equal to 0%, greater than or equal to 2%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, greater than or equal to 55%, greater than or equal to 60%, greater than or equal to 65%, or greater than or equal to 70% of the thickness of the fiber web. In some embodiments, a plurality of cavities has an average depth of less than or equal to 75%, less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, or less than or equal to 5% of the thickness of the fiber web. Combinations of these ranges are also possible (e.g., greater than or equal to 0% and less than or equal to 75%, or greater than or equal to 2% and less than or equal to 50%). Other ranges are also possible.

The average depth of a plurality of cavities of a surface-treated fiber web may be measured using a laser system to collect obtain a topographic map of the top and bottom surfaces of the surface-treated fiber web. The average depth of a plurality cavities on a side of the surface-treated fiber web may be estimated by identifying the peaks identified on the surface of the surface-treated fiber web, and determining the average depth of the cavities between consecutive pairs of peaks. The average depth of the cavities can be expressed as a percentage of the average thickness of the surface-treated fiber web, which may be determined using techniques discussed elsewhere herein. An exemplary laser system that may be used is the Mate Gauge laser system, used in the examples below.

A surface-treated fiber web described herein may comprise a plurality of cavities having any of a variety of suitable average areas. In some embodiments, a surface-treated fiber web comprises a plurality of cavities having an average area of greater than or equal to 1 micrometer², greater than or equal to 5 micrometer², greater than or equal to 10 micrometer², greater than or equal to 20 micrometer², greater than or equal to 30 micrometer², greater than or equal to 40 micrometer², greater than or equal to 50 micrometer², greater than or equal to 60 micrometer², greater than or equal to 70 micrometer², greater than or equal to 80 micrometer², greater than or equal to 90 micrometer², greater than or equal to 100 micrometer², greater than or equal to 110 micrometer², greater than or equal to 120 micrometer², greater than or equal to 130 micrometer², or greater than or equal to 140 micrometer². In some embodiments, a surface-treated fiber web comprises a plurality of cavities having an average area of less than or equal to 150 micrometer², less than or equal to 140 micrometer², less than or equal to 130 micrometer², less than or equal to 120 micrometer², less than or equal to 110 micrometer², less than or equal to 100 micrometer², less than or equal to 90 micrometer², less than or equal to 80 micrometer², less than or equal to 70 micrometer², less than or equal to 60 micrometer², less than or equal to 50 micrometer², less than or equal to 40 micrometer², less than or equal to 30 micrometer², less than or equal to 20 micrometer², less than or equal to 10 micrometer², or less than or equal to 5 micrometer². Combinations of these ranges are also possible (e.g., greater than or equal to 1 micrometer² and less than or equal to 150 micrometer², greater than or equal to 1 micrometer² and less than or equal to 100 micrometer², or greater than or equal to 1 micrometer² and less than or equal to 50 micrometer²). Other ranges are also possible.

It should, of course, be understood that the pluralities of cavities from each side of a surface-treated filter media may each, independently have an average area falling within one of the aforementioned ranges.

The individual areas of the cavities of a plurality of cavities may be determined by using a scanning electron microscope (SEM) to image a representative portion of a surface-treated fiber web and determining the area of each imaged cavity using the procedure for determining cavity area described elsewhere herein. The average area of the cavities of the plurality of cavities can then be computed by averaging the individual areas of the cavities.

Large cavities as defined herein are cavities that individually have an area greater than or equal to 1,000 micrometer². It may be advantageous, according to some embodiments, for a surface-treated fiber web to have a relatively low average area for large cavities. In some embodiments, a surface-treated fiber web comprises a plurality of cavities wherein the large cavities have an average area of less than or equal to 2,000 micrometer², less than or equal to 1,900 micrometer², less than or equal to 1,800 micrometer², less than or equal to 1,700 micrometer², less than or equal to 1,600 micrometer², less than or equal to 1,500 micrometer², less than or equal to 1,400 micrometer², less than or equal to 1,300 micrometer², less than or equal to 1,200 micrometer², or less than or equal to 1,100 micrometer². In some embodiments, a surface-treated fiber web comprises a plurality of cavities wherein the large cavities have an average area of greater than 1,000 micrometer², greater than or equal to 1,100 micrometer², greater than or equal to 1,200 micrometer², greater than or equal to 1,300 micrometer², greater than or equal to 1,400 micrometer², greater than or equal to 1,500 micrometer², greater than or equal to 1,600 micrometer², greater than or equal to 1,700 micrometer², greater than or equal to 1,800 micrometer², or greater than or equal to 1,900 micrometer². Combinations of these ranges are also possible (e.g., greater than 1,000 micrometer² and less than or equal to 2,000 micrometer², greater than or equal to 1,100 micrometer² and less than or equal to 1,500 micrometer², or greater than 1,000 micrometer² and less than or equal to 1,300 micrometer²). Other ranges are also possible.

It should, of course, be understood that the pluralities of cavities from each side of a surface-treated filter media may each, independently have an average area for large cavities that falls within one of the aforementioned ranges.

The individual areas of the cavities of a plurality of cavities may be determined by using a scanning electron microscope (SEM) to image a representative portion of a surface-treated fiber web and determining the area of each imaged cavity using the procedure for determining cavity area described elsewhere herein. The average area of the large cavities of the plurality of cavities can then be computed by averaging the individual areas of cavities with an area exceeding 1,000 micrometer².

Intermediate cavities as defined herein are cavities that individually have an area greater than or equal to 100 micrometer² and less than or equal to 1,000 micrometer². It may be advantageous, according to some embodiments, for a surface-treated fiber web to have a relatively low average area for intermediate and large cavities. In some embodiments, a surface-treated fiber web comprises a plurality of cavities wherein the intermediate and large cavities together have an average area of less than or equal to 1,100 micrometer², less than or equal to 1,000 micrometer², less than or equal to 900 micrometer², less than or equal to 800 micrometer², less than or equal to 700 micrometer², less than or equal to 600 micrometer², less than or equal to 500 micrometer², less than or equal to 400 micrometer², less than or equal to 300 micrometer², less than or equal to 200 micrometer², or less than or equal to 150 micrometer². In some embodiments, a surface-treated fiber web comprises a plurality of cavities wherein the intermediate and large cavities together have an average area of greater than 100 micrometer², greater than or equal to 150 micrometer², greater than or equal to 200 micrometer², greater than or equal to 300 micrometer², greater than or equal to 400 micrometer², greater than or equal to 500 micrometer², greater than or equal to 600 micrometer², greater than or equal to 700 micrometer², greater than or equal to 800 micrometer², greater than or equal to 900 micrometer², or greater than or equal to 1,000 micrometer². Combinations of these ranges are also possible (e.g., greater than 100 micrometer² and less than or equal to 1,100 micrometer², greater than or equal to 150 micrometer² and less than or equal to 1,000 micrometer², or greater than 100 micrometer² and less than or equal to 500 micrometer²). Other ranges are also possible.

It should, of course, be understood that the pluralities of cavities from each side of a surface-treated filter media may each, independently have an average area for intermediate and large cavities that falls within one of the aforementioned ranges.

The individual areas of the cavities of a plurality of cavities may be determined by using a scanning electron microscope (SEM) to image a representative portion of a surface-treated fiber web and determining the area of each imaged cavity using the procedure for determining cavity area described elsewhere herein. The average area of the intermediate and large cavities together can then be computed by averaging the individual areas of cavities with an area exceeding 100 micrometer².

A surface-treated fiber web described herein may comprise a plurality of cavities covering any of a variety of suitable percentages of the area of the surface-treated fiber web. In some embodiments, a surface-treated fiber web comprises a plurality of cavities covering greater than or equal to 1%, greater than or equal to 5%, greater than or equal to 10%, greater than or equal to 15%, greater than or equal to 20%, greater than or equal to 25%, greater than or equal to 30%, or greater than or equal to 35% of a surface of the surface-treated fiber web by area. In some embodiments, a surface-treated fiber web comprises a plurality of cavities covering less than or equal to 40%, less than or equal to 35%, less than or equal to 30%, less than or equal to 25%, less than or equal to 20%, less than or equal to 15%, less than or equal to 10%, or less than or equal to 5% of a surface of the surface-treated fiber web by area. Combinations of these ranges are also possible (e.g., greater than or equal to 1% and less than or equal to 40%, greater than or equal to 1% and less than or equal to 30%, greater than or equal to 5% and less than or equal to 25%, or greater than or equal to 10% and less than or equal to 25%). Other ranges are also possible.

It should, of course, be understood that the pluralities of cavities from each side of a surface-treated filter media may each, independently have an area coverage that falls within one of the aforementioned ranges.

The individual areas of the cavities of a plurality of cavities may be determined by using a scanning electron microscope (SEM) to image a representative portion of a surface-treated fiber web and determining the area of each imaged cavity using the procedure for determining cavity area described elsewhere herein. The average area percentage of the surface-treated fiber web occupied by the cavities of the plurality of cavities can then be computed by totaling the individual areas occupied by the cavities of the plurality and dividing by the total area of the representative portion of the surface-treated fiber web.

A surface-treated fiber web described herein may have any of a variety of suitable cross-dimensional cavity frequencies. In some embodiments, a surface-treated fiber web has a cross-dimensional cavity frequency of greater than or equal to 3000 cavities/m, greater than or equal to 3500 cavities/m, greater than or equal to 4000 cavities/m, greater than or equal to 4500 cavities/m, greater than or equal to 5000 cavities/m, greater than or equal to 5500 cavities/m, greater than or equal to 6000 cavities/m, greater than or equal to 6500 cavities/m, greater than or equal to 7000 cavities/m, greater than or equal to 7500 cavities/m, greater than or equal to 8000 cavities/m, greater than or equal to 8500 cavities/m, greater than or equal to 9000 cavities/m, or greater than or equal to 9500 cavities/m. In some embodiments, a surface-treated fiber web has a cross-dimensional cavity frequency of less than or equal to 10000 cavities/m, less than or equal to 9500 cavities/m, less than or equal to 9000 cavities/m, less than or equal to 8500 cavities/m, less than or equal to 8000 cavities/m, less than or equal to 7500 cavities/m, less than or equal to 7000 cavities/m, less than or equal to 6500 cavities/m, less than or equal to 6000 cavities/m, less than or equal to 5500 cavities/m, less than or equal to 5000 cavities/m, less than or equal to 4500 cavities/m, less than or equal to 4000 cavities/m, or less than or equal to 3500 cavities/m. Combinations of these ranges are also possible (e.g., greater than or equal to 3000 cavities/m and less than or equal to 10000 cavities/m, greater than or equal to 3500 cavities/m and less than or equal to 10000 cavities/m, or greater than or equal to 4000 cavities/m and less than or equal to 10000 cavities/m). Other ranges are also possible.

It should, of course, be understood that the pluralities of cavities from each side of a surface-treated filter media may each, independently have cross-dimensional cavity frequency that falls within one of the aforementioned ranges.

The cross-dimensional cavity frequency of a surface-treated fiber web may be measured using a laser system to collect obtain a topographic map of the top and bottom surfaces of the surface-treated fiber web. The cross-dimensional cavity frequency may be estimated by dividing the number of peaks identified on a surface of the surface-treated fiber web by a linear distance scanned by the laser system. An exemplary laser system that may be used is the Mate Gauge laser system, used in the examples below.

In some embodiments, a surface-treated fiber web advantageously has a relatively high developed interfacial area ratio. Without wishing to be bound by any particular theory, it is believed that surface-treated fiber webs having relatively high developed interfacial area ratios may have enhanced air permeability and/or dust holding capacity. In some embodiments, a surface-treated fiber web has a developed interfacial area ratio of greater than or equal to 0.1, greater than or equal to 0.12, greater than or equal to 0.15, greater than or equal to 0.18, greater than or equal to 0.2, greater than or equal to 0.3, greater than or equal to 0.5, greater than or equal to 0.8, greater than or equal to 1, greater than or equal to 1.1, greater than or equal to 1.2, greater than or equal to 1.4, greater than or equal to 1.6, greater than or equal to 1.8, greater than or equal to 2, greater than or equal to 3, greater than or equal to 4, greater than or equal to 5, greater than or equal to 8, greater than or equal to 10, greater than or equal to 15, greater than or equal to 20, greater than or equal to 30, or greater than or equal to 40. In some embodiments, a surface-treated fiber web has a developed interfacial area ratio of less than or equal to 50, less than or equal to 40, less than or equal to 30, less than or equal to 20, less than or equal to 15, less than or equal to 10, less than or equal to 8, less than or equal to 5, less than or equal to 4, less than or equal to 3, less than or equal to 2, less than or equal to 1.8, less than or equal to 1.6, less than or equal to 1.4, less than or equal to 1.2, less than or equal to 1.1, less than or equal to 1, less than or equal to 0.8, less than or equal to 0.5, less than or equal to 0.3, less than or equal to 0.2, less than or equal to 0.18, less than or equal to 0.15, or less than or equal to 0.12. Combinations of the above-referenced ranges are also possible (e.g., greater than or equal to 0.1 and less than or equal to 50, greater than or equal to 0.15 and less than or equal to 10, or greater than or equal to 0.2 and less than or equal to 5). Other ranges are also possible.

The developed interfacial area ratio may be determined with the aid of a scanning optical microscope, such as a Keyence VR 5000. For example, the scanning optical microscope may be employed to measure the surface topography of a 24.1 mm×18.1 mm sample of the surface-treated fiber web according to the standard described in ISO 25178 (2006). The surface topography may be measured in a manner yielding pixels having an edge length of 11.7 microns. This measurement yields a matrix of numerical values representing the measured surface height at a set of points on the sample, where the x- and y-positions of each measured surface height are given by the column and row, respectively, of the matrix. Then, a reference plane may be determined in accordance with ISO 25178 (2012). After the relative surface topography is determined, a surface shape correction may be applied thereto to yield a corrected relative surface topography. The correction strength may be equal to the width (24.1 mm) of the sample divided by 5. Finally, the interfacial area ratio may be determined by solving the following equation for Sdr:

$$S d r = \frac{1}{A} [ \int {\int }_{A} ( \sqrt{[ 1 + {( \frac{\partial z ( x , y )}{\partial x} )}^{2} + {( \frac{\partial z ( x , y )}{\partial y} )}^{2} ]} - 1 ) dxdy ] ,$$

where A is the area of the sample over which the surface topography was measured, and z is the corrected relative surface height.

When a filter media comprises two or more surface-treated fiber webs, each surface-treated fiber web may independently have a developed interfacial area ratio in one or more of the above-referenced ranges.

A surface-treated fiber web described herein may have any of a variety of suitable thicknesses. In some embodiments, a surface-treated fiber web has a thickness of greater than or equal to 0.1 mm, greater than or equal to 0.15 mm, greater than or equal to 0.2 mm, greater than or equal to 0.4 mm, greater than or equal to 0.6 mm, greater than or equal to 0.8 mm, greater than or equal to 1 mm, greater than or equal to 1.5 mm, greater than or equal to 2.0 mm, greater than or equal to 2.5 mm, greater than or equal to 3.0 mm, greater than or equal to 3.5 mm, greater than or equal to 4.0 mm, greater than or equal to 4.5 mm, greater than or equal to 5.0 mm, greater than or equal to 6.0 mm, or greater than or equal to 7.0 mm. In some embodiments, a surface-treated fiber web has a thickness of less than or equal to 8.0 mm, less than or equal to 7.0 mm, less than or equal to 6.0 mm, less than or equal to 5.0 mm, less than or equal to 4.5 mm, less than or equal to 4.0 mm, less than or equal to 3.5 mm, less than or equal to 3.0 mm, less than or equal to 2.5 mm, less than or equal to 2.0 mm, less than or equal to 1.5 mm, less than or equal to 1.0 mm, less than or equal to 0.8 mm, less than or equal to 0.6 mm, less than or equal to 0.4 mm, less than or equal to 0.2 mm, or less than or equal to 0.15 mm. Combinations of these ranges are also possible (e.g., greater than or equal to 0.1 mm and less than or equal to 8.0 mm, greater than or equal to 0.1 mm and less than or equal to 5.0 mm, greater than or equal to 0.15 mm and less than or equal to 2.0 mm, or greater than or equal to 0.2 mm and less than or equal to 1.0 mm). Other ranges are also possible.

The basis weight of a surface-treated fiber web may be determined in accordance with ISO 534 (2011) at 2 N/cm².

A surface-treated fiber web described herein may have a variety of suitable basis weights. In some embodiments, a surface-treated fiber web has a basis weight of greater than or equal to 5 gsm, greater than or equal to 10 gsm, greater than or equal to 15 gsm, greater than or equal to 20 gsm, greater than or equal to 25 gsm, greater than or equal to 30 gsm, greater than or equal to 40 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 350 gsm, greater than or equal to 400 gsm, or greater than or equal to 450 gsm. In some embodiments, a surface-treated fiber web has a basis weight of less than or equal to 500 gsm, less than or equal to 450 gsm, less than or equal to 400 gsm, less than or equal to 350 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 40 gsm, less than or equal to 30 gsm, less than or equal to 25 gsm, less than or equal to 20 gsm, less than or equal to 15 gsm, or less than or equal to 10 gsm. Combinations of the above-referenced ranges are also possible (e.g., greater than or equal to 5 gsm and less than or equal to 500 gsm, greater than or equal to 10 gsm and less than or equal to 300 gsm, greater than or equal to 30 gsm and less than or equal to 200 gsm, or greater than or equal to 30 gsm and less than or equal to 100 gsm). Other ranges are also possible.

The basis weight of a surface-treated fiber web may be determined in accordance with ISO 536:2012.

A surface-treated fiber web described herein may have any of a variety of suitable air permeabilities. In some embodiments, a surface-treated fiber web has an air permeability of greater than or equal to 0.1 cfm/sf (CFM), greater than or equal to 0.2 CFM, greater than or equal to 0.5 CFM, greater than or equal to 0.75 CFM, greater than or equal to 1 CFM, greater than or equal to 2 CFM, greater than or equal to 5 CFM, greater than or equal to 7.5 CFM, greater than or equal to 10 CFM, greater than or equal to 20 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 225 CFM, greater than or equal to 250 CFM, greater than or equal to 275 CFM, greater than or equal to 300 CFM, greater than or equal to 325 CFM, greater than or equal to 350 CFM, greater than or equal to 400 CFM, greater than or equal to 500 CFM, or greater than or equal to 750 CFM. In some embodiments, a surface-treated fiber web has an air permeability of less than or equal to 1000 CFM, less than or equal to 750 CFM, less than or equal to 500 CFM, less than or equal to 400 CFM, less than or equal to 350 CFM, less than or equal to 325 CFM, less than or equal to 300 CFM, less than or equal to 275 CFM, less than or equal to 250 CFM, less than or equal to 225 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 20 CFM, less than or equal to 10 CFM, less than or equal to 7.5 CFM, less than or equal to 5 CFM, less than or equal to 2 CFM, less than or equal to 1 CFM, less than or equal to 0.75 CFM, less than or equal to 0.5 CFM, or less than or equal to 0.2 CFM. Combinations of the above-referenced ranges are also possible (e.g., greater than or equal to 0.1 CFM and less than or equal to 1000 CFM, greater than or equal to 0.1 CFM and less than or equal to 800 CFM, greater than or equal to 10 CFM and less than or equal to 500 CFM, or greater than or equal to 30 CFM and less than or equal to 400 CFM). Other ranges are also possible.

The air permeability of a surface-treated fiber web may be determined in accordance with ASTM D737-04 (2016) at a pressure of 125 Pa.

The surface-treated fiber webs described herein may a variety of suitable mean flow pore sizes. The mean flow pore size of a surface-treated fiber web may be greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 40 microns, greater than or equal to 60 microns, greater than or equal to 80 microns, greater than or equal to 100 microns, greater than or equal to 125 microns, greater than or equal to 150 microns, or greater than or equal to 175 microns. The mean flow pore size of a surface-treated fiber web may be less than or equal to 200 microns, less than or equal to 175 microns, less than or equal to 150 microns, less than or equal to 100 microns, less than or equal to 80 microns, less than or equal to 60 microns, less than or equal to 40 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 microns and less than or equal to 200 microns, greater than or equal to 0.1 microns and less than or equal to 100 microns, greater than or equal to 1 micron and less than or equal to 60 microns, or greater than or equal to 1 micron and less than or equal to 40 microns). Other ranges are also possible.

The mean flow pore size of a surface-treated fiber web may be determined in accordance with ASTM F316 (2003).

The surface-treated fiber webs described herein may a variety of suitable maximum pore sizes. The maximum pore size of a surface-treated fiber web may be greater than or equal to 0.1 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 20 microns, greater than or equal to 40 microns, greater than or equal to 60 microns, greater than or equal to 80 microns, greater than or equal to 100 microns, greater than or equal to 125 microns, greater than or equal to 150 microns, greater than or equal to 175 microns, greater than or equal to 200 microns, greater than or equal to 225 microns, greater than or equal to 250 microns, or greater than or equal to 275 microns. The maximum pore size of a surface-treated fiber web may be less than or equal to 300 microns, less than or equal to 275 microns, less than or equal to 250 microns, less than or equal to 225 microns, less than or equal to 200 microns, less than or equal to 175 microns, less than or equal to 150 microns, less than or equal to 100 microns, less than or equal to 80 microns, less than or equal to 60 microns, less than or equal to 40 microns, less than or equal to 20 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 microns and less than or equal to 300 microns, greater than or equal to 0.1 microns and less than or equal to 200 microns, or greater than or equal to 2 microns and less than or equal to 100 microns). Other ranges are also possible.

The maximum pore size of a surface-treated fiber web may be determined in accordance with ASTM F316 (2003).

A surface-treated fiber web may have any of a variety of suitable apparent densities. The apparent density of a surface-treated fiber web may be greater than or equal to 30, greater than or equal to 40 gsm/mm, gsm/mm, greater than or equal to 50 gsm/mm, greater than or equal to 60 gsm/mm, greater than or equal to 70 gsm/mm, greater than or equal to 80 gsm/mm, greater than or equal to 90 gsm/mm, greater than or equal to 100 gsm/mm, greater than or equal to 125 gsm/mm, greater than or equal to 150 gsm/mm, greater than or equal to 175 gsm/mm, greater than or equal to 200 gsm/mm, greater than or equal to 300 gsm/mm, or greater than or equal to 400 gsm/mm. The apparent density of a surface-treated fiber web may be less than or equal to 500 gsm/mm, less than or equal to 400 gsm/mm, less than or equal to 300 gsm/mm, less than or equal to 200 gsm/mm, less than or equal to 175 gsm/mm, less than or equal to 150 gsm/mm, less than or equal to 125 gsm/mm, less than or equal to 100 gsm/mm, less than or equal to 90 gsm/mm, less than or equal to 80 gsm/mm, less than or equal to 70 gsm/mm, less than or equal to 60 gsm/mm, less than or equal to 50 gsm/mm, or less than or equal to 40 gsm/mm. Combinations of the above-referenced ranges are also possible (e.g., greater than or equal to 30 gsm/mm and less than or equal to 500 gsm/mm, greater than or equal to 50 gsm/mm and less than or equal to 200 gsm/mm, or greater than or equal to 60 gsm/mm and less than or equal to 175 gsm/mm). Other ranges are also possible.

The apparent density of a surface-treated fiber web may be determined by dividing the density of the surface-treated fiber web by the thickness of the surface-treated fiber web.

In some embodiments, a surface-treated fiber web described herein comprises synthetic fibers (e.g., monocomponent synthetic fibers, multicomponent synthetic fibers). The synthetic fibers may comprise binder fibers and/or non-binder fibers. Alternatively or additionally, the surface-treated fiber web may comprise non-synthetic fibers such as natural fibers (e.g., hard wood fibers, soft wood fibers, cellulose fibers) and/or glass fibers. In some embodiments, the use of synthetic fibers is in surface-treated fiber webs is particularly advantageous for use in filter media.

A surface-treated fiber web described herein may comprise synthetic fibers in any of a variety of suitable amounts. In some embodiments, a surface-treated fiber web comprises synthetic fibers in an amount of greater than or equal to 1 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt %. In some embodiments, a surface-treated fiber web comprises synthetic fibers in an amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less than or equal to 5 wt %. Combinations of these ranges are also possible (e.g., greater than or equal to 1 wt % and less than or equal to 100 wt %, greater than or equal to 50 wt % and less than or equal to 100 wt %, or greater than or equal to 80 wt % and less than or equal to 100 wt %). Other ranges are also possible.

A surface-treated fiber web described herein may comprise synthetic fibers having any of a variety of suitable diameters. In some embodiments, a surface-treated fiber web comprises synthetic fibers having an average diameter of greater than or equal to 0.01 microns, greater than or equal to 0.02 microns, greater than or equal to 0.05 microns, greater than or equal to 0.1 microns, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, greater than or equal to 30 microns, greater than or equal to 40 microns, greater than or equal to 50 microns, or greater than or equal to 60 microns, greater than or equal to 70 microns, or greater than or equal to 80 microns. In some embodiments, a surface-treated fiber web comprises synthetic fibers having an average diameter of less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 10 microns, less than or equal to 5 microns, less than or equal to 2 microns, less than or equal to 1 micron, less than or equal to 0.5 microns, less than or equal to 0.2 microns, less than or equal to 0.1 microns, or less than or equal to 0.05 microns. Combinations of these ranges are also possible (e.g., greater than or equal to 0.01 microns and less than or equal to 100 microns, greater than or equal to 0.01 microns and less than or equal to 50 microns, greater than or equal to 1 micron and less than or equal to 20 microns, or greater than or equal to 5 microns and less than or equal to 20 microns). Other ranges are also possible.

A surface-treated fiber web described herein may comprise synthetic fibers having any of a variety of suitable lengths. In some embodiments, a surface-treated fiber web comprises synthetic fibers having an average length of greater than or equal to 0.1 mm, greater than or equal to 0.5 mm, greater than or equal to 1 mm, greater than or equal to 2 mm, greater than or equal to 4 mm, greater than or equal to 6 mm, greater than or equal to 8 mm, greater than or equal to 10 mm, greater than or equal to 12 mm, greater than or equal to 14 mm, greater than or equal to 16 mm, greater than or equal to 18 mm, greater than or equal to 20 mm, greater than or equal to 25 mm, greater than or equal to 30 mm, greater than or equal to 35 mm, greater than or equal to 40 mm, or greater than or equal to 45 mm. In some embodiments, a surface-treated fiber web comprises synthetic fibers having an average length of less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 18 mm, less than or equal to 16 mm, less than or equal to 14 mm, less than or equal to 12 mm, less than or equal to 10 mm, less than or equal to 8 mm, less than or equal to 6 mm, less than or equal to 4 mm, less than or equal to 2 mm, less than or equal to 1 mm, or less than or equal to 0.5 mm. Combinations of these ranges are also possible (e.g., greater than or equal to 0.1 mm and less than or equal to 50 mm, greater than or equal to 0.1 mm and less than or equal to 40 mm, greater than or equal to 1 mm and less than or equal to 20 mm, or greater than or equal to 4 mm and less than or equal to 20 mm). Other ranges are also possible.

In some embodiments, a surface-treated fiber web comprises synthetic fibers that are binder fibers. In some such embodiments, the binder fibers may include one type of binder fibers (e.g., monocomponent fibers, multicomponent fibers) or more than one type of binder fibers (e.g., both monocomponent fibers and multicomponent fibers, two types of monocomponent fibers, two types of multicomponent fibers). In some such embodiments, the binder fibers may serve as a binder for the surface-treated fiber web that binds fibers within the web together, as disclosed elsewhere herein.

A surface-treated fiber web described herein may comprise binder fibers in any of a variety of suitable amounts. In some embodiments, a surface-treated fiber web comprises binder fibers in an amount of greater than or equal to 0 wt %, greater than or equal to 1 wt %, greater than or equal to 2 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, or greater than or equal to 65 wt %. In some embodiments, a surface-treated fiber web comprises binder fibers in an amount of less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, or less than or equal to 1 wt %. Combinations of these ranges are also possible (e.g., greater than or equal to 0 wt % and less than or equal to 70 wt %, greater than or equal to 0 wt % and less than or equal to 50 wt %, greater than or equal to 1 wt % and less than or equal to 30 wt %, or greater than or equal to 2 wt % and less than or equal to 30 wt %). Other ranges are also possible.

A surface-treated fiber web described herein may comprise binder fibers having any of a variety of suitable diameters. In some embodiments, a surface-treated fiber web comprises binder fibers having an average diameter of greater than or equal to 0.01 microns, greater than or equal to 0.02 microns, greater than or equal to 0.05 microns, greater than or equal to 0.1 microns, greater than or equal to 0.2 microns, greater than or equal to 0.5 microns, greater than or equal to 1 micron, greater than or equal to 2 microns, greater than or equal to 5 microns, greater than or equal to 10 microns, greater than or equal to 20 microns, greater than or equal to 30 microns, greater than or equal to 40 microns, greater than or equal to 50 microns, or greater than or equal to 60 microns, greater than or equal to 70 microns, or greater than or equal to 80 microns. In some embodiments, a surface-treated fiber web comprises binder fibers having an average diameter of less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, less than or equal to 20 microns, less than or equal to 10 microns, less than or equal to 5 microns, less than or equal to 2 microns, less than or equal to 1 micron, less than or equal to 0.5 microns, less than or equal to 0.2 microns, less than or equal to 0.1 microns, or less than or equal to 0.05 microns. Combinations of these ranges are also possible (e.g., greater than or equal to 0.01 microns and less than or equal to 100 microns, greater than or equal to 0.01 microns and less than or equal to 50 microns, greater than or equal to 1 micron and less than or equal to 20 microns, or greater than or equal to 5 microns and less than or equal to 20 microns). Other ranges are also possible.

A surface-treated fiber web described herein may comprise binder fibers having any of a variety of suitable lengths. In some embodiments, a surface-treated fiber web comprises binder fibers having an average length of greater than or equal to 0.1 mm, greater than or equal to 0.5 mm, greater than or equal to 1 mm, greater than or equal to 2 mm, greater than or equal to 4 mm, greater than or equal to 6 mm, greater than or equal to 8 mm, greater than or equal to 10 mm, greater than or equal to 12 mm, greater than or equal to 14 mm, greater than or equal to 16 mm, greater than or equal to 18 mm, greater than or equal to 20 mm, greater than or equal to 25 mm, greater than or equal to 30 mm, greater than or equal to 35 mm, greater than or equal to 40 mm, or greater than or equal to 45 mm. In some embodiments, a surface-treated fiber web comprises binder fibers having an average length of less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 18 mm, less than or equal to 16 mm, less than or equal to 14 mm, less than or equal to 12 mm, less than or equal to 10 mm, less than or equal to 8 mm, less than or equal to 6 mm, less than or equal to 4 mm, less than or equal to 2 mm, less than or equal to 1 mm, or less than or equal to 0.5 mm. Combinations of these ranges are also possible (e.g., greater than or equal to 0.1 mm and less than or equal to 50 mm, greater than or equal to 0.1 mm and less than or equal to 40 mm, greater than or equal to 1 mm and less than or equal to 20 mm, or greater than or equal to 4 mm and less than or equal to 20 mm). Other ranges are also possible.

Binder fibers are multicomponent fibers, in some embodiments. Multicomponent fibers may be bicomponent fibers (i.e., fibers including two components), and/or may be fibers comprising three or more components. Multicomponent fibers may have a variety of suitable structures. For instance, multicomponent fibers may comprise one or more of the following types of bicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, allowing the sheath to act as a binder. In such embodiments, the multicomponent fibers may serve as a binder for the layer.

Non-limiting examples of suitable materials that may be included in multicomponent fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Co-poly(ethylene terephthalate)s may include repeat units formed by polymerization of comonomers (e.g., monomers other than ethylene glycol and terephthalic acid) in a variety of suitable amounts. For instance, a co-poly(ethylene terephthalate) may be formed from a mixture of monomers in which the comonomer may make up greater than or equal to 0.5 mol %, greater than or equal to 0.75 mol %, greater than or equal to 1 mol %, greater than or equal to 1.5 mol %, greater than or equal to 2 mol %, greater than or equal to 3 mol %, greater than or equal to 5 mol %, greater than or equal to 7.5 mol %, greater than or equal to 10 mol %, or greater than or equal to 12.5 mol % of the total amount of monomers. The co-poly(ethylene terephthalate) may be formed from a mixture of monomers in which the comonomer makes up less than or equal to 15 mol %, less than or equal to 12.5 mol %, less than or equal to 10 mol %, less than or equal to 7.5 mol %, less than or equal to 5 mol %, less than or equal to 3 mol %, less than or equal to 2 mol %, less than or equal to 1.5 mol %, less than or equal to 1 mol %, or less than or equal to 0.75 mol % of the total amount of monomers. Combinations of the above-referenced ranges are also possible (e.g., greater than or equal to 0.5 mol % and less than or equal to 15 mol %). Other ranges are also possible.

In embodiments in which a co-poly(ethylene terephthalate) comprises two or more types of repeat units formed by polymerization of a comonomer, each type of repeat unit may independently make up a mol % of the total amount of monomers from which the co-poly(ethylene terephthalate) is formed in one or more of the ranges described above and/or all of the comonomers together may make up a mol % of the total amount of monomers from which the co-poly(ethylene terephthalate) is formed in one or more of the ranges described above.

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

The multicomponent fibers described herein may comprise components having a variety of suitable melting points. In some embodiments, a multicomponent fiber comprises a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a multicomponent fiber comprises a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C. The melting point of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

In some embodiments, a surface-treated fiber web comprises synthetic fibers that are not binder fibers. Such synthetic fibers may comprise monocomponent synthetic fibers and/or multicomponent synthetic fibers. When present, the multicomponent synthetic fibers that are not binder fibers may have one or more of the morphologies described elsewhere herein with respect to multicomponent binder fibers.

Non-binder synthetic fibers may comprise a variety of materials, including, but not limited to, poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone) s.

Non-binder synthetic fibers may make up a variety of suitable amounts of the surface-treated fiber webs described herein. In some embodiments, non-binder synthetic fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of the surface-treated fiber web. In some embodiments, non-binder synthetic fibers make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt %. Combinations of the above-referenced ranges are also possible (e.g., greater than or equal to 0 wt % and less than or equal to 95 wt %, greater than or equal to 5 wt % and less than or equal to 80 wt %, or greater than or equal to 10 wt % and less than or equal to 70 wt %). Other ranges are also possible.

When a surface-treated fiber web comprises two or more types of non-binder synthetic fibers, each type of non-binder synthetic fiber may independently make up an amount of the surface-treated fiber web in one or more of the ranges described above and/or all of the non-binder synthetic fibers in a surface-treated fiber web may together make up an amount of the surface-treated fiber web in one or more of the ranges described above. Similarly, when a filter media comprises two or more surface-treated fiber webs, each surface-treated fiber web may independently comprise an amount of any particular type of non-binder synthetic fiber in one or more of the ranges described above and/or may comprise a total amount of non-binder synthetic fibers in one or more of the ranges described above.

Non-binder synthetic fibers present in surface-treated fiber webs may have a variety of suitable average fiber diameters. In some embodiments, a surface-treated fiber web comprises non-binder synthetic fibers having an average fiber diameter of greater than or equal to 0.01 microns, greater than or equal to 0.02 microns, greater than or equal to 0.05 microns, greater than or equal to 0.1 microns, greater than or equal to 0.2 microns, greater than or equal to 0.5 microns, greater than or equal to 1 micron, greater than or equal to 1.5 microns, greater than or equal to 2 microns, greater than or equal to 2.5 microns, greater than or equal to 3 microns, greater than or equal to 5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 55 microns, greater than or equal to 60 microns, greater than or equal to 65 microns, greater than or equal to 70 microns, greater than or equal to 75 microns, greater than or equal to 80 microns, greater than or equal to 85 microns, greater than or equal to 90 microns, or greater than or equal to 95 microns. In some embodiments, a surface-treated fiber web comprises non-binder synthetic fibers with an average fiber diameter of less than or equal to 100 microns, less than or equal to 95 microns, less than or equal to 90 microns, less than or equal to 85 microns, less than or equal to 80 microns, less than or equal to 75 microns, less than or equal to 70 microns, less than or equal to 65 microns, less than or equal to 60 microns, less than or equal to 55 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, less than or equal to 3 microns, less than or equal to 2.5 microns, less than or equal to 2 microns, less than or equal to 1.5 microns, less than or equal to 1 micron, less than or equal to 0.5 microns, less than or equal to 0.2 microns, less than or equal to 0.1 microns, less than or equal to 0.05 microns, or less than or equal to 0.02 microns. Combinations of the above-referenced ranges are also possible (e.g., greater than or equal to 0.01 microns and less than or equal to 100 microns, greater than or equal to 0.1 microns and less than or equal to 100 microns, greater than or equal to 0.5 microns and less than or equal to 50 microns, or greater than or equal to 2 microns and less than or equal to 20 microns). Other ranges are also possible.

When a surface-treated fiber web comprises two or more types of non-binder synthetic fibers, each type of non-binder synthetic fiber may independently have an average fiber diameter in one or more of the ranges described above and/or all of the non-binder synthetic fibers in a surface-treated fiber web may together have an average fiber diameter in one or more of the ranges described above. Similarly, when a filter media comprises two or more surface-treated fiber webs, each surface-treated fiber web may independently comprise one or more types of non-binder synthetic fibers having an average fiber diameter in one or more of the ranges described above and/or may comprise non-binder synthetic fibers that overall have an average fiber diameter in one or more of the ranges described above.

Non-binder synthetic fibers present in surface-treated fiber webs may have a variety of suitable average fiber lengths. In some embodiments, a surface-treated fiber web comprises non-binder synthetic fibers having an average length of greater than or equal to 0.1 mm, greater than or equal to 0.5 mm, greater than or equal to 1 mm, greater than or equal to 2 mm, greater than or equal to 4 mm, greater than or equal to 6 mm, greater than or equal to 8 mm, greater than or equal to 10 mm, greater than or equal to 12 mm, greater than or equal to 14 mm, greater than or equal to 16 mm, greater than or equal to 18 mm, greater than or equal to 20 mm, greater than or equal to 25 mm, greater than or equal to 30 mm, greater than or equal to 35 mm, greater than or equal to 40 mm, or greater than or equal to 45 mm. In some embodiments, a surface-treated fiber web comprises non-binder synthetic fibers having an average length of less than or equal to 50 mm, less than or equal to 45 mm, less than or equal to 40 mm, less than or equal to 35 mm, less than or equal to 30 mm, less than or equal to 25 mm, less than or equal to 20 mm, less than or equal to 18 mm, less than or equal to 16 mm, less than or equal to 14 mm, less than or equal to 12 mm, less than or equal to 10 mm, less than or equal to 8 mm, less than or equal to 6 mm, less than or equal to 4 mm, less than or equal to 2 mm, less than or equal to 1 mm, or less than or equal to 0.5 mm. Combinations of these ranges are also possible (e.g., greater than or equal to 0.1 mm and less than or equal to 50 mm, greater than or equal to 0.1 mm and less than or equal to 40 mm, greater than or equal to 1 mm and less than or equal to 20 mm, or greater than or equal to 4 mm and less than or equal to 20 mm). Other ranges are also possible.

When a surface-treated fiber web comprises two or more types of non-binder synthetic fibers, each type of non-binder synthetic fiber may independently have an average fiber length in one or more of the ranges described above and/or all of the non-binder synthetic fibers in a surface-treated fiber web may together have an average fiber length in one or more of the ranges described above. Similarly, when a filter media comprises two or more surface-treated fiber webs, each surface-treated fiber web may independently comprise one or more types of non-binder synthetic fibers having an average fiber length in one or more of the ranges described above and/or may comprise non-binder synthetic fibers that overall have an average fiber length in one or more of the ranges described above.

In some embodiments, binder resins may be included in the surface-treated fiber webs described herein. In some embodiments, a binder resin makes up greater than or equal to 0 wt %, greater than or equal to 1 wt %, greater than or equal to 2 wt %, greater than or equal to 3 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, or greater than or equal to 35 wt % of a surface-treated fiber web. In some embodiments, a binder resin makes up less than or equal to 40 wt %, less than or equal to 35 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 3 wt %, less than or equal to 2 wt %, or less than or equal to 1 wt % of a surface-treated fiber web. Combinations of the above-referenced ranges are also possible (e.g., greater than or equal to 0 wt % and less than or equal to 40 wt %, greater than or equal to 1 wt % and less than or equal to 30 wt %, or greater than or equal to 1 wt % and less than or equal to 20 wt %). Other ranges are also possible. In some embodiments, a binder resin makes up exactly 0 wt % of a surface-treated fiber web.

When a surface-treated fiber web comprises two or more types of binder resin, each type of binder resin may independently make up an amount of the surface-treated fiber web in one or more of the ranges described above and/or all of the binder resin in a surface-treated fiber web may together make up an amount of the surface-treated fiber web in one or more of the ranges described above. Similarly, when a filter media comprises two or more surface-treated fiber webs, each surface-treated fiber web may independently comprise an amount of any particular type of binder resin in one or more of the ranges described above and/or may comprise a total amount of binder resin in one or more of the ranges described above.

Binder resins may have a variety of suitable compositions. For instance, in one set of embodiments, a filter media may comprise a binder resin that comprises a thermoplastic polymer (e.g. acrylic, polyvinyl acetate, polyester, polyamide, polycarboxylic acid, nylon, etc.), a thermoset polymer (e.g., epoxy, phenolic resin, melamine, etc.), or a combination thereof. In some embodiments, a binder resin includes one or more of a vinyl acetate resin and a polyvinyl alcohol resin. In some embodiments, a binder resin is provided in the form of a powder. In some embodiments, a surface-treated fiber web comprises a binder powder. Non-limiting examples of suitable powders include phenolic binder powders, epoxy binder powders, co-polyester binder powders, and nylon binder powders.

In another aspect, a filter media comprising a plurality of adsorbent particles is provided. The adsorbent particles may be at least partially disposed on a surface-treated fiber web as discussed above. In some embodiments, the adsorbent particles are at least partially disposed within cavities of the plurality of cavities, as discussed with reference to FIG. 2 above. As mentioned above, in some embodiments, the adsorbent particles form a layer (e.g., a second layer) on the surface-treated fiber web. However, this is not necessary, and often the adsorbent particles are distributed preferentially within the cavities of the surface-treated fiber web. In some embodiments, the non-woven fiber web includes adsorbent particles within the non-woven fiber web (e.g., intermingled between fibers of the non-woven fiber web).

A filter media described herein may comprise adsorbent particles having any of a variety of suitable basis weights. In some embodiments, a filter media comprises adsorbent particles having a basis weight of greater than or equal to 20 gsm, greater than or equal to 40 gsm, greater than or equal to 60 gsm, greater than or equal to 80 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, greater than or equal to 500 gsm, greater than or equal to 600 gsm, greater than or equal to 700 gsm, greater than or equal to 800 gsm, greater than or equal to 900 gsm, greater than or equal to 1000 gsm, or greater than or equal to 1100 gsm. In some embodiments, a filter media comprises adsorbent particles having a basis weight of less than or equal to 1200 gsm, less than or equal to 1100 gsm, less than or equal to 1000 gsm, less than or equal to 900 gsm, less than or equal to 800 gsm, less than or equal to 700 gsm, less than or equal to 600 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 80 gsm, less than or equal to 60 gsm, or less than or equal to 40 gsm. Combinations of these ranges are also possible (e.g., greater than or equal to 20 gsm and less than or equal to 1200 gsm, greater than or equal to 20 gsm and less than or equal to 1000 gsm, greater than or equal to 40 gsm and less than or equal to 500 gsm, or greater than or equal to 40 gsm and less than or equal to 300 gsm). Other ranges are also possible.

A filter media described herein may comprise adsorbent particle in any of a variety of suitable proportions, relative to the overall weight of the filter media. In some embodiments, a filter media comprises adsorbent particles in an amount of greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %, or greater than or equal to 98 wt %. In some embodiments, a filter media comprises adsorbent particles in an amount of less than or equal to 99 wt %, less than or equal to 98 wt %, less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, or less than or equal to 2 wt %. Combinations of these ranges are also possible (e.g., greater than or equal to 1 wt % and less than or equal to 99 wt %, greater than or equal to 10 wt % and less than or equal to 90 wt %, or greater than or equal to 40 wt % and less than or equal to 80 wt %). Other ranges are also possible.

A filter media described herein may comprise adsorbent particles having any of a variety of suitable diameters. In some embodiments, a filter media comprises adsorbent particles having an average diameter of greater than or equal to 1 micrometer, greater than or equal to 2 micrometers, greater than or equal to 3 micrometers, greater than or equal to 4 micrometers, greater than or equal to 5 micrometers, greater than or equal to 6 micrometers, greater than or equal to 7 micrometers, greater than or equal to 8 micrometers, greater than or equal to 9 micrometers, greater than or equal to 10 micrometers, greater than or equal to 20 micrometers, greater than or equal to 30 micrometers, greater than or equal to 40 micrometers, greater than or equal to 50 micrometers, greater than or equal to 80 micrometers, greater than or equal to 100 micrometers, greater than or equal to 150 micrometers, greater than or equal to 200 micrometers, greater than or equal to 250 micrometers, greater than or equal to 300 micrometers, greater than or equal to 350 micrometers, greater than or equal to 400 micrometers, greater than or equal to 450 micrometers, greater than or equal to 500 micrometers, greater than or equal to 600 micrometers, greater than or equal to 700 micrometers, greater than or equal to 800 micrometers, greater than or equal to 900 micrometers, greater than or equal to 1000 micrometers, greater than or equal to 1500 micrometers, greater than or equal to 2000 micrometers, greater than or equal to 2500 micrometers, greater than or equal to 3000 micrometers, greater than or equal to 3500 micrometers, greater than or equal to 4000 micrometers, or greater than or equal to 4500 micrometers. In some embodiments, a filter media comprises adsorbent particles having an average diameter of less than or equal to 5000 micrometers, less than or equal to 4500 micrometers, less than or equal to 4000 micrometers, less than or equal to 3500 micrometers, less than or equal to 3000 micrometers, less than or equal to 2500 micrometers, less than or equal to 2000 micrometers, less than or equal to 1500 micrometers, less than or equal to 1000 micrometers, less than or equal to 900 micrometers, less than or equal to 800 micrometers, less than or equal to 700 micrometers, less than or equal to 600 micrometers, less than or equal to 500 micrometers, less than or equal to 450 micrometers, less than or equal to 400 micrometers, less than or equal to 350 micrometers, less than or equal to 300 micrometers, less than or equal to 250 micrometers, less than or equal to 200 micrometers, less than or equal to 150 micrometers, less than or equal to 100 micrometers, less than or equal to 80 micrometers, less than or equal to 50 micrometers, less than or equal to 40 micrometers, less than or equal to 30 micrometers, less than or equal to 20 micrometers, less than or equal to 10 micrometers, less than or equal to 9 micrometers, less than or equal to 8 micrometers, less than or equal to 7 micrometers, less than or equal to 6 micrometers, less than or equal to 5 micrometers, less than or equal to 4 micrometers, less than or equal to 3 micrometers, or less than or equal to 2 micrometers. Combinations of these ranges are also possible (e.g., greater than or equal to 1 micrometer and less than or equal to 5000 micrometers, greater than or equal to 5 micrometers and less than or equal to 800 micrometers, or greater than or equal to 5 micrometers and less than or equal to 200 micrometers). Other ranges are also possible.

Adsorbent particles for use in filter media may have any of a variety of suitable compositions and properties. For example, in some embodiments, the adsorbent particles are conductive particles. As another example, in some embodiments, the adsorbent particles are capacitive particles. Representative properties and compositions of various adsorbent particles are discussed in greater detail below.

Any of a variety of adsorbent, conductive particles may be used. In some embodiments, the conductive particles comprise carbon-containing materials. The carbon-containing materials may include carbon black, acetylene black, graphite, graphene, and/or carbon nanotubes. The conductive particles may comprise one or more of the materials described above throughout the particle (e.g., the particle may be formed from one or more of the materials described above), or may comprise one or more of the materials described above as a coating (e.g., on a core of a different composition).

When present, the conductive particles may have any suitable average electrical conductivity. The average electrical conductivity of the conductive particles may be greater than or equal to 1 S/m, greater than or equal to 2 S/m, greater than or equal to 5 S/m, greater than or equal to 10 S/m, greater than or equal to 20 S/m, greater than or equal to 50 S/m, greater than or equal to 100 S/m, greater than or equal to 200 S/m, greater than or equal to 500 S/m, greater than or equal to 1,000 S/m, greater than or equal to 2,000 S/m, greater than or equal to 5,000 S/m, greater than or equal to 10,000 S/m, greater than or equal to 20,000 S/m, greater than or equal to 50,000 S/m, greater than or equal to 100,000 S/m, greater than or equal to 200,000 S/m, or greater than or equal to 250,000 S/m. The average electrical conductivity of the conductive particles may be less than or equal to 300,000 S/m, less than or equal to 250,000 S/m, less than or equal to 200,000 S/m, less than or equal to 100,000 S/m, less than or equal to 50,000 S/m, less than or equal to 20,000 S/m, less than or equal to 10,000 S/m, less than or equal to 5,000 S/m, less than or equal to 2,000 S/m, less than or equal to 1.000 S/m, less than or equal to 500 S/m, less than or equal to 200 S/m, less than or equal to 100 S/m, less than or equal to 50 S/m, less than or equal to 20 S/m, less than or equal to 10 S/m, less than or equal to 5 S/m, or less than or equal to 2 S/m. Combinations of the above-referenced ranges are also possible (e.g., greater than or equal to 1 S/m and less than or equal to 300,000 S/m, greater than or equal to 5 S/m and less than or equal to 250,000 S/m, or greater than or equal to 10 S/m and less than or equal to 200,000 S/m). Other ranges are also possible.

The average electrical conductivity of the conductive particles may be determined by applying a pressure of 500 lbs/in² to press the conductive particles into a pellet of known length and cross-sectional area, applying a voltage across the pellet, measuring the current across the pellet, dividing the voltage by the current to determine the resistance of the pellet, and then dividing the inverse of the resistance by the ratio of the cross-sectional area of the pellet to the length of the pellet.

Any of a variety of adsorbent, capacitive particles may be used. In some embodiments, the capacitive particles comprise carbon-containing materials. The carbon-containing materials may include activated carbon. The capacitive particles may comprise one or more of the materials described above throughout the particle (e.g., the particle may be formed from one or more of the materials described above), or may comprise one or more of the materials described above as a coating (e.g., on a core of a different composition).

When present, the capacitive particles may have any suitable average specific capacitance. The average specific capacitance of the capacitive particles may be greater than or equal to 1 F/g, greater than or equal to 2 F/g, greater than or equal to 5 F/g, greater than or equal to 10 F/g, greater than or equal to 20 F/g, greater than or equal to 50 F/g, greater than or equal to 100 F/g, greater than or equal to 200 F/g, greater than or equal to 250 F/g, or greater than or equal to 400 F/g. The average specific capacitance of the capacitive particles may be less than or equal to 500 F/g, less than or equal to 400 F/g, less than or equal to 250 F/g, less than or equal to 200 F/g, less than or equal to 100 F/g, less than or equal to 50 F/g, less than or equal to 20 F/g, less than or equal to 10 F/g, less than or equal to 5 F/g, or less than or equal to 2 F/g. Combinations of the above-referenced ranges are also possible (e.g., greater than or equal to 1 F/g and less than or equal to 500 F/g, greater than or equal to 10 F/g and less than or equal to 250 F/g, or greater than or equal to 20 F/g and less than or equal to 200 F/g). Other ranges are also possible.

The average specific capacitance of the capacitive particles may be determined in accordance with IEC 62576:2018. Briefly, this method involves: (1) constructing a symmetric supercapacitor/ultracapacitor device including two identical electrodes comprising the capacitive particles, a separator, and a 1.28 spg sulfuric acid electrolyte; (2) measuring the voltage as a function of time during a constant current charge-discharge test performed across voltages varying from 0 V to 1 V; (3) identifying a period of time over which the voltage decreases linearly with time; (4) multiplying the slope of the voltage decrease as a function of time in this time period by the discharge current to determine the capacitance of the particles; and (5) multiplying the measured capacitance of the particles by 4 and dividing this value by the mass of the active material in each electrode. The identical electrodes comprising the capacitive particles may be formed and prepared for use in the symmetric supercapacitor/ultracapacitor device by a process comprising: (1) mixing together the capacitive particles and carbon black particles with an average diameter of 200 nm at a weight ratio of 18:1; (2) diluting a dispersion of 60 wt % PTFE solids (average solids diameter 50 nm; dispersion density 1.50 g/cm³) in water to form a 5 wt % dispersion of PTFE solids in water; (3) mixing the 5 wt % PTFE dispersion with the mixture of capacitive particles and carbon black particles to form an electrode precursor with a ratio of capacitive particles:carbon black particles:PTFE of 90:5:5; (4) rolling the electrode precursor to form a layer of the electrode precursor with a thickness of 150 microns and a density of 1 mg/mm³; (5) drying the layer of the electrode precursor in an oven at 75° C. for 12 hours; (6) cutting 4 cm×4 cm square electrodes from the dried electrode precursor; and (7) attaching 316 stainless steel sheets with a thickness of 0.018 cm to the square electrodes.

In some embodiments, a filter media as described herein may comprise both a plurality of conductive adsorbent particles and a plurality of capacitive adsorbent particles.

In some embodiments a surface-treated fiber web (e.g., a backer) comprises the adsorbent particles. In some embodiments, an additional layer (e.g., a layer disposed on a surface-treated fiber web, a stand-alone layer that is a capacitance layer) or a stand-alone layer (e.g., a stand-alone layer that is a capacitance layer) comprises the adsorbent particles. In some embodiments, the adsorbent particles form an adsorbent particle layer at least partially disposed on a surface-treated fiber web as described above.

As discussed above with reference to FIGS. 3A-3B, in some embodiments a filter media comprises one or more additional layers other than the surface-treated fiber webs (e.g., backer layers) and/or adsorbent particle layers described above. Non-limiting examples of suitable additional layers include prefilter layers and protective layers. In some embodiments, a filter media comprises an additional layer that is a scrim (e.g., a prefilter layer that is also a scrim, a protective layer that is also a scrim). The additional layer(s) may be attached to another layer in the fiber web (e.g., a backer layer, another additional layer) in a variety of suitable manners, such as with an adhesive, by use of a calender, and/or by ultrasonic bonding. Other possible additional layers include: a backer, a charged layer, an uncharged layer, a wetlaid layer, a drylaid layer, a support layer, or a spacer layer. An additional layer may be produced by any of a variety of appropriate methods. For example, an additional layer may be wetlaid, drylaid, spunbonded, or meltblown. The additional layer may be formed directly on another layer (e.g., on a surface-treated fiber web layer) or may be formed separately and subsequently laminated together with the other layer.

When present, an additional layer may have a wide variety of properties. In some embodiments, the additional layer does not contribute appreciably to the filtration performance of the filter media. In other embodiments, the additional layer does contribute to one or more properties of the filter media. For instance, the additional layer may serve as a prefilter layer. As another example, a relatively large percentage of the total pressure drop across the filter media may occur across the additional layer. This may be beneficial when one or more other layers in the filter media are relatively fragile and/or may not be able to withstand a large pressure drop.

It should be understood that any individual additional layer may independently have some or all of the properties described below with respect to additional layers. It should also be understood that a filter media may comprise two additional layers that are identical and/or may comprise two or more additional layers that differ in one or more ways.

When present, an additional layer may comprise a non-woven fiber web comprising a plurality of fibers. A variety of suitable types of non-woven fiber webs may be employed as additional layers in the filter media described herein. For instance, a filter media may comprise an additional layer comprising a wetlaid non-woven fiber web, a non-wetlaid non-woven fiber web (such as, e.g., a meltblown non-woven fiber web, an airlaid non-woven fiber web, a carded non-woven fiber web, a spunbond non-woven fiber web), an electrospun non-woven fiber web, a scrim, and/or another type of non-woven fiber web.

In embodiments in which more than one additional layer is present, each additional layer may independently be of one or more of the types described above.

When present, an additional layer may comprise a plurality of fibers comprising a variety of suitable types of fibers. In some embodiments, an additional layer comprises a plurality of fibers comprising synthetic fibers and/or is made up of synthetic fibers (in other words, it may be a synthetic layer). The synthetic fibers may be of any of the types and compositions mentioned elsewhere herein (e.g., the synthetic fibers may be binder fibers or non-binder synthetic fibers).

In some embodiments, an additional layer comprises a plurality of fibers comprising natural fibers (e.g., hard wood fibers, soft wood fibers, cellulose fibers) and/or regenerated cellulose fibers. For example, cellulose fibers can be hardwood or soft wood fibers. Cellulose fibers can be other than natural cellulose fibers. As an example, the cellulose fibers may comprise regenerated and/or synthetic cellulose such as rayon, lyocell, and celluloid. As another example, the cellulose fibers comprise natural cellulose derivatives, such as cellulose acetate and carboxymethylcellulose. The cellulose fibers, when present, may comprise fibrillated cellulose fibers, and/or may comprise un-fibrillated cellulose fibers. In some embodiments, the additional layer comprises glass fibers.

The additional layer may include more than one type of fiber (e.g., binder fibers and non-binder synthetic fibers) or may include exclusively one type of fiber.

When an additional layer comprises a plurality of fibers comprising synthetic fibers (e.g., binder fibers), the additional layer may have any suitable amount of synthetic fibers. For example, in some embodiments, the synthetic fibers (e.g., binder fibers) are present in the additional layer in an amount greater than or equal to 0 wt %, greater than or equal to 1 wt %, greater than or equal to 2 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % versus the total weight of the additional layer. In some embodiments, the synthetic fibers (e.g., binder fibers) are present in the additional layer in an amount less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, less than or equal to 5 wt %, less than or equal to 2 wt %, or less than or equal to 1 wt % versus the total weight of the additional layer. Combinations of the above-referenced ranges are also possible (e.g., greater than or equal to 0 wt % and less than or equal to 100 wt %, greater than or equal to 1 wt % and less than or equal to 100 wt %, greater than or equal to 50 wt % and less than or equal to 100 wt %, greater than or equal to 1% and less than or equal to 30%, or greater than or equal to 80 wt % and less than or equal to 100 wt %). Other ranges are also possible. In some embodiments, synthetic fibers may be present in the additional layer in an amount of 100 wt % versus the total weight of the additional layer and/or versus the total weight of the fibers in the additional layer. When present, multiple types of synthetic fibers (e.g., binder fibers, non-binder synthetic fibers) may each individually be included in a weight percentage falling within an aforementioned range.

When present, an additional layer may have any suitable average fiber diameter, regardless of the types of fibers present. For example, in some embodiments, the additional layer has an average fiber diameter of greater than or equal to 0.01 microns, greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, the additional layer has an average fiber diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.01 microns and less than or equal to 100 microns, greater than or equal to 0.1 microns and less than or equal to 75 microns, or greater than or equal to 0.5 microns and less than or equal to 25 microns). Other ranges are also possible. The average diameter may be determined by scanning electron microscopy.

When an additional layer comprises a plurality of fibers comprising synthetic fibers, the synthetic fibers (e.g., binder fibers) therein may have a variety of average diameters. In some embodiments, an additional layer comprises synthetic fibers (e.g., binder fibers) having an average diameter of greater than or equal to 0.01 microns, greater than or equal to 0.05 microns, greater than or equal to 0.075 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, an additional layer comprises synthetic fibers (e.g., binder fibers) having an average diameters of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 micron, or less than or equal to 0.075 microns. Combinations of the above-referenced ranges are also possible (e.g., greater than or equal to 0.01 microns and less than or equal to 100 microns, greater than or equal to 0.01 microns and less than or equal to 50 microns, greater than or equal to 0.1 microns and less than or equal to 20 microns, greater than or equal to 1 micron and less than or equal to 20 microns, greater than or equal to 10 microns and less than or equal to 60 microns, greater than or equal to 17 microns and less than or equal to 35 microns, greater than or equal to 0.05 microns and less than or equal to 50 microns, greater than or equal to 0.05 microns and less than or equal to 30 microns, greater than or equal to 0.05 microns and less than or equal to 5 microns, greater than or equal to 0.05 microns and less than or equal to 2 microns, greater than or equal to 0.075 microns and less than or equal to 0.5 microns, greater than or equal to 0.15 microns and less than or equal to 3 microns, greater than or equal to 0.25 microns and less than or equal to 3 microns, or greater than or equal to 0.25 microns and less than or equal to 2 microns). Other ranges are also possible. The average diameter may be determined by scanning electron microscopy.

The fibers in a plurality of fibers in an additional layer, if present, may have a variety of suitable average lengths. In some embodiments, the average length of the fibers in an additional layer is greater than or equal to 0.01 mm, greater than or equal to 0.1 mm, greater than or equal to 0.2 mm, greater than or equal to 0.3 mm, greater than or equal to 0.4 mm, greater than or equal to 0.5 mm, greater than or equal to 0.75 mm, greater than or equal to 1 mm, greater than or equal to 1.25 mm, greater than or equal to 1.5 mm, greater than or equal to 2 mm, greater than or equal to 3 mm, greater than or equal to 4 mm, greater than or equal to 5 mm, greater than or equal to 6 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, or greater than or equal to 75 mm. In some embodiments, the average length of the fibers in an additional layer is less than or equal to 300 mm, less than or equal to 250 mm, less than or equal to 200 mm, less than or equal to 150 mm, less than or equal to 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 12 mm, less than or equal to 10 mm, less than or equal to 7.5 mm, less than or equal to 5 mm, less than or equal to 4 mm, less than or equal to 3 mm, less than or equal to 2.5 mm, less than or equal to 2 mm, less than or equal to 1.5 mm, less than or equal to 1.25 mm, less than or equal to 1 mm, less than or equal to 0.75 mm, less than or equal to 0.5 mm, or less than or equal to 0.4 mm. Combinations of the above-referenced ranges are also possible (e.g., greater than or equal to 0.01 mm and less than or equal to 300 mm, greater than or equal to 0.1 mm and less than or equal to 300 mm, greater than or equal to 0.1 mm and less than or equal to 25 mm, greater than or equal to 0.1 mm and less than or equal to 12 mm, greater than or equal to 0.3 mm and less than 100 mm, greater than or equal to 1 mm and less than or equal to 70 mm, greater than or equal to 1 mm and less than or equal to 10 mm, greater than or equal to 3 mm and less than or equal to 300 mm, greater than or equal to 6 mm and less than or equal to 100 mm, or greater than or equal to 1 mm and less than or equal to 50 mm). Other ranges are also possible.

In embodiments in which more than one additional layer is present, each additional layer may independently comprise fibers having an average length in one or more of the ranges described above.

In some embodiments, an additional layer comprises continuous fibers, which may have a variety of suitable lengths. For instance, the average length of the fibers in a additional layer may be greater than or equal to 100 mm, greater than or equal to 125 mm, greater than or equal to 150 mm, greater than or equal to 200 mm, greater than or equal to 250 mm, greater than or equal to 300 mm, greater than or equal to 400 mm, greater than or equal to 500 mm, greater than or equal to 750 mm, greater than or equal to 1 m, greater than or equal to 1.25 m, greater than or equal to 1.5 m, greater than or equal to 2 m, greater than or equal to 2.5 m, greater than or equal to 3 m, greater than or equal to 4 m, greater than or equal to 5 m, greater than or equal to 7.5 m, greater than or equal to 10 m, greater than or equal to 12.5 m, greater than or equal to 15 m, greater than or equal to 20 m, greater than or equal to 25 m, greater than or equal to 30 m, greater than or equal to 40 m, greater than or equal to 50 m, greater than or equal to 75 m, greater than or equal to 100 m, greater than or equal to 125 m, greater than or equal to 150 m, greater than or equal to 200 m, greater than or equal to 250 m, greater than or equal to 300 m, greater than or equal to 400 m, greater than or equal to 500 m, or greater than or equal to 750 m. In some embodiments, the average length of the fibers in a additional layer is less than or equal to 1 km, less than or equal to 750 m, less than or equal to 500 m, less than or equal to 400 m, less than or equal to 300 m, less than or equal to 250 m, less than or equal to 200 m, less than or equal to 150 m, less than or equal to 125 m, less than or equal to 100 m, less than or equal to 75 m, less than or equal to 50 m, less than or equal to 40 m, less than or equal to 30 m, less than or equal to 25 m, less than or equal to 20 m, less than or equal to 15 m, less than or equal to 12.5 m, less than or equal to 10 m, less than or equal to 7.5 m, less than or equal to 5 m, less than or equal to 4 m, less than or equal to 3 m, less than or equal to 2.5 m, less than or equal to 2 m, less than or equal to 1.5 m, less than or equal to 1.25 m, less than or equal to 1 m, less than or equal to 750 mm, less than or equal to 500 mm, less than or equal to 400 mm, less than or equal to 300 mm, less than or equal to 250 mm, less than or equal to 200 mm, less than or equal to 150 mm, or less than or equal to 125 mm. Combinations of the above-referenced ranges are also possible (e.g., greater than or equal to 100 mm and less than or equal to 1 km, greater than or equal to 125 mm and less than or equal to 25 m, greater than or equal to 125 mm and less than or equal to 2 m). Other ranges are also possible.

In embodiments in which more than one additional layer is present, each additional layer may independently comprise fibers having an average length in one or more of the ranges described above.

Some additional layers include components other than fibers. For instance, an additional layer may comprise a binder resin. The binder resin may make up less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1.25 wt %, less than or equal to 1 wt %, less than or equal to 0.75 wt %, less than or equal to 0.5 wt %, less than or equal to 0.4 wt %, less than or equal to 0.3 wt %, less than or equal to 0.25 wt %, less than or equal to 0.2 wt %, less than or equal to 0.15 wt %, less than or equal to 0.125 wt %, or less than or equal to 0.1 wt % of the additional layer. The binder resin may make up greater than or equal to 0 wt %, greater than or equal to 0.1 wt %, greater than or equal to 0.125 wt %, greater than or equal to 0.15 wt %, greater than or equal to 0.2 wt %, greater than or equal to 0.25 wt %, greater than or equal to 0.3 wt %, greater than or equal to 0.4 wt %, greater than or equal to 0.5 wt %, greater than or equal to 0.75 wt %, greater than or equal to 1 wt %, greater than or equal to 1.25 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, or greater than or equal to 25 wt % of the additional layer. Combinations of the above-referenced ranges are also possible (e.g., greater than or equal to 0 wt % and less than or equal to 90 wt %, or greater than or equal to 10 wt % and less than or equal to 30 wt %). Other ranges are also possible. In some embodiments, the additional layer is binder resin-free (i.e., binder resin makes up 0 wt % of the additional layer).

In embodiments in which more than one additional layer is present, each additional layer may independently comprise a binder resin in an amount in one or more of the ranges described above. Suitable binder resins are described elsewhere herein.

The thickness of the additional layer may be selected as desired. For instance, in some embodiments, the additional layer may have a thickness of greater than or equal to 10 nm, greater than or equal to 20 nm, greater than or equal to 30 nm, greater than or equal to 40 nm, greater than or equal to 50 nm, greater than or equal to 100 nm, greater than or equal to 500 nm, greater than or equal to 1 micron, greater than or equal to 0.02 mm, greater than or equal to 0.05 mm, greater than or equal to 0.1 mm, greater than or equal to 0.2 mm, greater than or equal to 0.4 mm, greater than or equal to 0.5 mm, greater than or equal to 0.8 mm, greater than or equal to 1.0 mm, greater than or equal to 2.0 mm, greater than or equal to 3.0 mm, or greater than or equal to 4.0 mm. In some instances, the additional layer may have a thickness of less than or equal to 10 mm, less than or equal to 9 mm, less than or equal to 8 mm, less than or equal to 7 mm, less than or equal to 6 mm, less than or equal to 5 mm, less than or equal to 3 mm, less than or equal to 2 mm, less than or equal to 1.2 mm, less than or equal to 1, less than or equal to 0.8 mm, less than or equal to 0.5 mm, less than or equal to 0.4 mm, or less than or equal to 0.2 mm. Combinations of the above-referenced ranges are also possible (e.g., a thickness of greater than or equal to 10 nm and less than or equal to 10 mm, greater than or equal to 0.02 mm and less than or equal to 10 mm, greater than or equal to 0.05 mm and less than or equal to 5 mm, greater than or equal to 0.1 mm and less than or equal to 5 mm, greater than or equal to 0.1 mm and less than or equal to 3 mm, or a thickness of greater than or equal to 0.1 mm and less than or equal to 1 mm). Other values of thickness are also possible. As determined herein, the thickness is measured according to the standard ISO 534 (2011) at 2 N/cm².

When present, an additional layer may have a variety of suitable solidities. In some embodiments, an additional layer has a solidity of greater than or equal to 0.001%, greater than or equal to 0.01%, greater than or equal to 0.1%, greater than or equal to 1%, greater than or equal to 2%, greater than or equal to 3%, greater than or equal to 4%, greater than or equal to 5%, greater than or equal to 7.5%, greater than or equal to 10%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, or greater than or equal to 60%. In some embodiments, an additional layer has a solidity of less than or equal to 70%, less than or equal to 60%, less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, less than or equal to 7.5%, or less than or equal to 5%. Combinations of the above-referenced ranges are also possible (e.g., greater than or equal to 0.001% and less than or equal to 50%, greater than or equal to 0.01% and less than or equal to 25%, greater than or equal to 4% and less than or equal to 90%, greater than or equal to 4% and less than or equal to 50%, greater than or equal to 5% and less than or equal to 40%, or greater than or equal to 5% and less than or equal to 35%). Other ranges are also possible. Solidity may be measured as described elsewhere herein. In embodiments in which more than one additional layer is present, each additional layer may independently have a solidity in one or more of the ranges described above.

When present, an additional layer may have a variety of suitable basis weights. In some embodiments, an additional layer has a basis weight of greater than or equal to 0.001 gsm, greater than or equal to 0.01 gsm, greater than or equal to 0.1 gsm, greater than or equal to 1 gsm, greater than or equal to 2 gsm, greater than or equal to 5 gsm, greater than or equal to 7.5 gsm, greater than or equal to 10 gsm, greater than or equal to 12.5 gsm, greater than or equal to 15 gsm, greater than or equal to 17.5 gsm, greater than or equal to 20 gsm, greater than or equal to 25 gsm, greater than or equal to 30 gsm, greater than or equal to 40 gsm, greater than or equal to 50 gsm, greater than or equal to 75 gsm, greater than or equal to 100 gsm, greater than or equal to 150 gsm, greater than or equal to 200 gsm, greater than or equal to 250 gsm, greater than or equal to 300 gsm, or greater than or equal to 400 gsm. In some embodiments, an additional layer has a basis weight of less than or equal to 1000 gsm, less than or equal to 900 gsm, less than or equal to 800 gsm, less than or equal to 700 gsm, less than or equal to 600 gsm, less than or equal to 500 gsm, less than or equal to 400 gsm, less than or equal to 300 gsm, less than or equal to 250 gsm, less than or equal to 200 gsm, less than or equal to 150 gsm, less than or equal to 120 gsm, less than or equal to 100 gsm, less than or equal to 75 gsm, less than or equal to 50 gsm, less than or equal to 40 gsm, less than or equal to 30 gsm, less than or equal to 25 gsm, less than or equal to 20 gsm, less than or equal to 17.5 gsm, less than or equal to 15 gsm, less than or equal to 12.5 gsm, less than or equal to 10 gsm, or less than or equal to 7.5 gsm. Combinations of the above-referenced ranges are also possible (e.g., greater than or equal to 0.001 gsm and less than or equal to 1000 gsm, greater than or equal to 2 gsm and less than or equal to 1000 gsm, greater than or equal to 5 gsm and less than or equal to 500 gsm, greater than or equal to 10 gsm and less than or equal to 300 gsm, greater than or equal to 15 gsm and less than or equal to 500 gsm, greater than or equal to 20 gsm and less than or equal to 300 gsm, greater than or equal to 20 gsm and less than or equal to 120 gsm, or greater than or equal to 30 gsm and less than or equal to 200 gsm). Other ranges of basis weight are also possible. The basis weight of an additional layer may be determined in accordance with ISO 536:2012.

In embodiments in which more than one additional layer is present, each additional layer may independently have a basis weight in one or more of the ranges described above.

When present, an additional layer may have a variety of suitable mean flow pore sizes. In some embodiments, an additional layer has a mean flow pore size of greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 75 microns, greater than or equal to 100 microns, greater than or equal to 125 microns, greater than or equal to 150 microns, or greater than or equal to 200 microns. In some embodiments, an additional layer has a mean flow pore size of less than or equal to 300 microns, less than or equal to 250 microns, less than or equal to 200 microns, less than or equal to 150 microns, less than or equal to 125 microns, less than or equal to 100 microns, less than or equal to 75 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 12.5 microns, less than or equal to 10 microns, less than or equal to 7.5 microns, less than or equal to 5 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.15 microns, or less than or equal to 0.125 microns. Combinations of the above-referenced ranges are also possible (e.g., greater than or equal to 0.1 micron and less than or equal to 300 microns, greater than or equal to 0.1 micron and less than or equal to 250 microns, greater than or equal to 1 micron and less than or equal to 100 microns, greater than or equal to 0.1 micron and less than or equal to 50 microns, greater than or equal to 0.2 microns and less than or equal to 35 microns, or greater than or equal to 0.2 microns and less than or equal to 30 microns). Other ranges are also possible.

The mean flow pore size of an additional layer may be determined in accordance with ASTM F316 (2003).

When present, an additional layer may have a variety of suitable air permeabilities. In some embodiments, an additional layer has an air permeability of greater than or equal to 0.5 CFM, greater than or equal to 0.75 CFM, greater than or equal to 1 CFM, greater than or equal to 1.25 CFM, greater than or equal to 1.5 CFM, greater than or equal to 2 CFM, greater than or equal to 2.5 CFM, greater than or equal to 3 CFM, greater than or equal to 4 CFM, greater than or equal to 5 CFM, greater than or equal to 7.5 CFM, greater than or equal to 8 CFM, greater than or equal to 10 CFM, greater than or equal to 12.5 CFM, greater than or equal to 15 CFM, greater than or equal to 20 CFM, greater than or equal to 25 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 200 CFM, greater than or equal to 250 CFM, greater than or equal to 300 CFM, greater than or equal to 400 CFM, greater than or equal to 500 CFM, greater than or equal to 750 CFM, greater than or equal to 1000 CFM, greater than or equal to 1250 CFM, greater than or equal to 1500 CFM, greater than or equal to 2000 CFM, greater than or equal to 2500 CFM, greater than or equal to 3000 CFM, or greater than or equal to 5000 CFM. In some embodiments, an additional layer has an air permeability of less than or equal to 8000 CFM, less than or equal to 5000 CFM, less than or equal to 3000 CFM, less than or equal to 2500 CFM, less than or equal to 2000 CFM, less than or equal to 1500 CFM, less than or equal to 1400 CFM, less than or equal to 1250 CFM, less than or equal to 1000 CFM, less than or equal to 750 CFM, less than or equal to 500 CFM, less than or equal to 400 CFM, less than or equal to 300 CFM, less than or equal to 250 CFM, less than or equal to 200 CFM, less than or equal to 150 CFM, less than or equal to 125 CFM, less than or equal to 100 CFM, less than or equal to 75 CFM, less than or equal to 50 CFM, less than or equal to 40 CFM, less than or equal to 30 CFM, less than or equal to 25 CFM, less than or equal to 20 CFM, less than or equal to 15 CFM, less than or equal to 12.5 CFM, less than or equal to 10 CFM, less than or equal to 7.5 CFM, less than or equal to 5 CFM, less than or equal to 4 CFM, less than or equal to 3 CFM, less than or equal to 2.5 CFM, less than or equal to 2 CFM, less than or equal to 1.5 CFM, less than or equal to 1.25 CFM, less than or equal to 1 CFM, or less than or equal to 0.75 CFM. Combinations of the above-referenced ranges are also possible (e.g., greater than or equal to 0.5 CFM and less than or equal to 8000 CFM, greater than or equal to 0.5 CFM and less than or equal to 2000 CFM, greater than or equal to 1 CFM and less than or equal to 1400 CFM, greater than or equal to 0.5 CFM and less than or equal to 800 CFM, greater than or equal to 1 CFM and less than or equal to 500 CFM, greater than or equal to 0.5 CFM and less than or equal to 400 CFM, greater than or equal to 0.5 CFM and less than or equal to 200 CFM, greater than or equal to 1 CFM and less than or equal to 150 CFM, greater than or equal to 5 CFM and less than or equal to 500 CFM, greater than or equal to 8 CFM and less than or equal to 400 CFM, or greater than or equal to 1 CFM and less than or equal to 100 CFM). Other ranges are also possible.

The air permeability may be determined in accordance with ASTM Test Standard D737-04 (2016) at a pressure of 125 Pa.

When present, an additional layer may have any suitable dust holding capacity. In certain embodiments, an additional layer has a dust holding capacity of greater than or equal to 10 gsm, greater than or equal to 20 gsm, greater than or equal to 30 gsm, greater than or equal to 40 gsm, greater than or equal to 50 gsm, greater than or equal to 75 gsm, greater than or equal to 100 gsm, greater than or equal to 125 gsm, greater than or equal to 150 gsm, greater than or equal to 200 gsm, greater than or equal to 250 gsm, greater than or equal to 300 gsm, greater than or equal to 350 gsm, or greater than or equal to 400 gsm. In some embodiments, an additional layer has a dust holding capacity of less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 125 gsm, less than or equal to 100 gsm, less than or equal to 75 gsm, or less than or equal to 50 gsm. Combinations of these ranges are also possible (e.g., greater than or equal to 10 gsm and less than or equal to 500 gsm or greater than or equal to 20 gsm and less than or equal to 450 gsm).

Dust holding capacity may be measured according to ISO 19438 (2013) using ISO medium test dust (A3).

When present, an additional layer (e.g., a backer layer, an additional layer) may have any suitable pressure drop. In certain embodiments, an additional layer has a pressure drop of greater than or equal to 0.05 kPa, greater than or equal to 0.1 kPa, greater than or equal to 0.3 kPA, greater than or equal to 0.5 kPa, greater than or equal to 1 kPa, greater than or equal to 3 kPa, greater than or equal to 5 kPA, greater than or equal to 10 kPa, greater than or equal to 15 kPa, greater than or equal to 20 kPa, greater than or equal to 25 kPa, greater than or equal to 30 kPa, greater than or equal to 40 kPa, greater than or equal to 50 kPa, or greater than or equal to 60 kPa. In some embodiments, an additional layer has a pressure drop of less than or equal to 80 kPa, less than or equal to 75 kPa, less than or equal to 70 kPa, less than or equal to 65 kPa, less than or equal to 60 kPa, less than or equal to 55 kPa, less than or equal to 50 kPa, less than or equal to 45 kPa, less than or equal to 40 kPa, less than or equal to 35 kPa, less than or equal to 30 kPa, less than or equal to 25 kPa, less than or equal to 20 kPa, less than or equal to 15 kPa, less than or equal to 10 kPa, or less than or equal to 5 kPa. Combinations of these ranges are also possible (e.g., greater than or equal to 0.05 kPa and less than or equal to 80 kPa or greater than or equal to 0.1 kPa and less than or equal to 50 kPa).

Pressure drop may be measured according to ASTM D2 986-91.

In some embodiments, an additional layer may be treated (e.g., to make it more oleophobic). For example, an additional layer includes an oleophobic component such as an oleophobic additive or an oleophobic coating and/or may have an oil rank of greater than or equal to 1. In some embodiments, the layer or layers having oleophobic properties (e.g., the layer or layers comprising an oleophobic component, the layer or layers having an oil rank of greater than or equal to 1) may confer one or more benefits on the filter media as a whole, such as a low pressure drop at a high oil loading, a high gamma at a high oil loading, and/or a low penetration at a high oil loading. One or more of these properties may be beneficial in applications where the filter media is positioned in an environment with a moderate or high ambient oil level. For example, the filter media may be used in clean rooms (e.g., pharmaceutical clean rooms, electronic clean rooms, clean rooms for integrated circuit manufacturing), in gas turbines (e.g., off shore gas turbines), in room air cleaners, in face masks, in vacuum cleaners, in paint spray booths, and/or to filter oily aerosols. In some embodiments, a filter media with a layer or layers having oleophobic properties (e.g., the layer or layers comprising an oleophobic component, the layer or layers with an oil rank of greater than or equal to 1) may be a HEPA filter, an ULPA filter, and/or a HVAC filter. Other types of filter media including oleophobic layers are also possible.

In some embodiments, one or more additional layers within a filter media have an oil rank of greater than or equal to 1, greater than or equal to 2, greater than or equal to 3, greater than or equal to 4, greater than or equal to 4.5, greater than or equal to 5, greater than or equal to 5.5, greater than or equal to 6, greater than or equal to 6.5, greater than or equal to 7, or greater than or equal to 7.5. In some embodiments, one or more additional layers within a filter media have an oil rank of less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3, or less than or equal to 2. Combinations of the above-referenced ranges are also possible (e.g., greater than or equal to 1 and less than or equal to 8, greater than or equal to 1 and less than or equal to 8, greater than or equal to 1 and less than or equal to 6, or greater than or equal to 5 and less than or equal to 6). Other ranges are also possible.

Oil rank as described herein is determined according to AATCC™ 118 (1997) measured at 23° C. and 50% relative humidity (RH). Briefly, 5 drops of each test oil (having an average droplet diameter of about 2 mm) are placed on five different locations on the surface of the fiber web. The test oil with the greatest oil surface tension that does not wet the surface of the fiber web (e.g., has a contact angle greater than or equal to 90 degrees with the surface) after 30 seconds of contact with the fiber web at 23° C. and 50% RH, corresponds to the oil rank (listed in Table 1). For example, if a test oil with a surface tension of 26.6 mN/m does not wet (i.e., has a contact angle of greater than or equal to 90 degrees with the surface) the surface of the fiber web after 30 seconds, but a test oil with a surface tension of 25.4 mN/m wets the surface of the fiber web within thirty seconds, the fiber web has an oil rank of 4. By way of another example, if a test oil with a surface tension of 25.4 mN/m does not wet the surface of the fiber web after 30 seconds, but a test oil with a surface tension of 23.8 mN/m wets the surface of the fiber web within thirty seconds, the fiber web has an oil rank of 5. By way of yet another example, if a test oil with a surface tension of 23.8 mN/m does not wet the surface of the fiber web after 30 seconds, but a test oil with a surface tension of 21.6 mN/m wets the surface of the fiber web within thirty seconds, the fiber web has an oil rank of 6. In some embodiments, if three of more of the five drops partially wet the surface (e.g., forms a droplet, but not a well-rounded drop on the surface) in a given test, then the oil rank is expressed to the nearest 0.5 value determined by subtracting 0.5 from the number of the test liquid. By way of example, if a test oil with a surface tension of 25.4 mN/m does not wet the surface of the fiber web after 30 seconds, but a test oil with a surface tension of 23.8 mN/m only partially wets the surface of the fiber web after 30 seconds (e.g., three or more of the test droplets form droplets on the surface of the fiber web that are not well-rounded droplets) within thirty seconds, the fiber web has an oil rank of 5.5.

TABLE 1

| Oil Rank | Test Oil | Surface Tension |
|---|---|---|
| 1 | Kaydol (mineral oil) | 31 |
| 2 | 65/35 Kaydol/n-hexadecane | 28 |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

A filter media described herein may comprise any of a variety of appropriate numbers of total layers (including all backer layers (e.g., surface-treated fiber webs of the type whose enhancement is described above), adsorbent particle layers, and/or additional layers). In some embodiments, a filter media includes greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, greater than or equal to 12, greater than or equal to 14, greater than or equal to 16, or greater than or equal to 18 total layers. In some embodiments, a filter media includes less than or equal to 20, less than or equal to 18, less than or equal to 16, less than or equal to 14, less than or equal to 12, less than or equal to 10, less than or equal to 9, less than or equal to 8, less than or equal to 7, less than or equal to 6, less than or equal to 5, less than or equal to 4, less than or equal to 3, or less than or equal to 2 total layers. Combinations of these ranges are also possible (e.g., greater than or equal to 1 and less than or equal to 25, greater than or equal to 1 and less than or equal to 10, or greater than or equal to 1 and less than or equal to 4). Other ranges are also possible.

In some embodiments two or more layers of the filter media may be formed separately and combined by any suitable method such as lamination, collation, or by use of adhesives. The two or more layers may be formed using different processes, or the same process. For example, each of the layers may be independently formed by an electrospinning process, a non-wet laid process (e.g., meltblown process, melt spinning process, centrifugal spinning process, electrospinning process, dry laid process, air laid process), a wet laid process, or any other suitable process.

Different layers may be adhered together by any suitable method. For instance, layers may be adhered by an adhesive and/or melt-bonded to one another on either side. Lamination and calendering processes may also be used. In some embodiments, an additional layer is formed from any type of fiber or blend of fibers via a wetlaid or non-wetlaid process and appropriately adhered to another layer.

In some embodiments, a filter media comprises an adhesive positioned between two or more layers. As also described above, some filter media described herein comprise adhesive positioned between two or more pairs of layers. It should be understood that an adhesive positioned between any specific pair of layers may have some or all of the properties described below with respect to adhesives. It should also be understood that a filter media may comprise two locations at which adhesive is positioned for which the adhesive has identical properties and/or may comprise two or more locations at which adhesive is positioned for which the adhesive differs in one or more ways.

In some embodiments, a filter media comprises an adhesive that is a solvent-based adhesive resin. As used herein, a solvent-based adhesive resin is an adhesive that is capable of undergoing a liquid to solid transition upon the evaporation of a solvent from the resin. Solvent-based adhesive resins may be applied while in the liquid state. Subsequently, the solvent that is present may evaporate to yield a solid adhesive. Solvent-based adhesives may thus be considered to be distinct from hot melt adhesives, which do not comprise volatile solvents (e.g., solvents that evaporate under normal operating conditions) and which typically undergo a liquid to solid transition as the adhesive cools. In embodiments in which adhesive is present at more than one location, each location at which adhesive is present may independently comprise an adhesive that is a solvent-based adhesive resin.

Desirable properties for adhesives may include sufficient tackiness and open time (i.e., the amount of time that the adhesive remains tacky after being exposed to the ambient atmosphere). Without wishing to be bound by theory, the tackiness of an adhesive may depend on both the glass transition temperature of the adhesive and the molecular weight of any polymeric components of the adhesive. Higher values of glass transition and lower values of molecular weight may promote enhanced tackiness, and higher values of molecular weight may result in higher cohesion in the adhesive and higher bond strength. In some embodiments, adhesives having a glass transition temperature and/or molecular weight in one or more ranges described herein may provide appropriate values of both tackiness and open time. For example, the adhesive may be configured to remain tacky for a relatively long time (e.g., the adhesive may remain tacky after full evaporation of any solvents initially present, and/or may be tacky indefinitely when held at room temperature). In some embodiments, the open time of the adhesive may be less than or equal to 24 hours, less than or equal to 12 hours, less than or equal to 6 hours, less than or equal to 1 hour, less than or equal to 30 minutes, less than or equal to 15 minutes, less than or equal to 10 minutes, less than or equal to 5 minutes, less than or equal to 3 minutes, less than or equal to 1 minute, less than or equal to 30 seconds, or less than or equal to 10 seconds. In some embodiments, the open time of the adhesive may be at least 1 second, at least 10 seconds, at least 15 seconds, at least 30 seconds, at least 1 minute, at least 3 minutes, at least 5 minutes, at least 10 minutes, at least 15 minutes, at least 30 minutes, at least 1 hour, at least 6 hours, or at least 12 hours. Combinations of the above-referenced ranges are also possible (e.g., at least 1 second and less than or equal to 24 hours). Other values are also possible. In embodiments in which adhesive is present at more than one location, each location at which adhesive is present may independently comprise an adhesive having an open time in one or more of the ranges described above.

Non-limiting examples of suitable adhesives include adhesives comprising acrylates, acrylate copolymers, poly(urethane)s, poly(ester)s, poly(vinyl alcohol), ethylene-vinyl acetate copolymers, silicone solvents, poly(olefin)s, synthetic and/or natural rubber, synthetic elastomers, ethylene-acrylic acid copolymers, ethylene-methacrylate copolymers, ethylene-methyl methacrylate copolymers, poly(vinylidene chloride), poly(amide)s, epoxies, melamine resins, poly(isobutylene), styrenic block copolymers, styrene-butadiene rubber, aliphatic urethane acrylates, and/or phenolics. In embodiments in which adhesive is present at more than one location, each location at which adhesive is present may independently comprise an adhesive comprising one or more of the materials described above.

When present, an adhesive may comprise a crosslinker and/or may be crosslinked. In certain embodiments, a crosslinker is less than or equal to 3000 g/mol. In some embodiments, the crosslinker is a small molecule as described above and/or the crosslink is a reaction product of a small molecule crosslinker as described above. In some embodiments, an adhesive comprises a small molecule crosslinker (and/or a reaction product thereof) that is one or more of a carbodiimide, an isocyanate, an aziridine, a zirconium compound such as zirconium carbonate, a metal acid ester, a metal chelate, a multifunctional propylene imine, and an amino resin. In some embodiments, the adhesive comprises at least one polymer and/or prepolymer with one or more reactive functional groups that are capable of reacting with the crosslinker and/or comprises a reaction product of one or more reactive functional groups on a polymer and/or prepolymer that have reacted with the crosslinker. Non-limiting examples of suitable reactive functional groups include alcohol groups, carboxylic acid groups, epoxy groups, amine groups, and amino groups. In some embodiments, a filter media comprises an adhesive that comprises one or more polymers and/or prepolymers that may undergo self-crosslinking via functional groups attached thereto. In some embodiments, a filter media comprises an adhesive that comprises a self-crosslinked reaction product of one or more polymers and/or prepolymers. In embodiments in which adhesive is present at more than one location, each location at which adhesive is present may independently comprise an adhesive comprising one or more of the materials described above.

When present, a small molecule crosslinker and/or crosslinks that are reaction products thereof may make up any suitable amount of an adhesive. In some embodiments, the wt % of the crosslinker and/or crosslinks that are reaction products thereof is greater than or equal to 0.1 wt %, greater than or equal to 0.2 wt %, greater than or equal to 0.5 wt %, greater than or equal to 1 wt %, greater than or equal to 2 wt %, greater than or equal to 5 wt %, greater than or equal to 10 wt %, greater than or equal to 15 wt %, greater than or equal to 20 wt %, or greater than or equal to 25 wt % with respect to the total mass of the adhesive. In some embodiments, the wt % of the small molecule crosslinker and/or crosslinks that are reaction products thereof is less than or equal to 30 wt %, less than or equal to 25 wt %, less than or equal to 20 wt %, less than or equal to 15 wt %, less than or equal to 10 wt %, less than or equal to 5 wt %, less than or equal to 2 wt %, less than or equal to 1 wt %, less than or equal to 0.5 wt %, or less than or equal to 0.2 wt % with respect to the total mass of the adhesive. Combinations of the above-referenced ranges are also possible (e.g., greater than or equal to 0.1 wt % and less than or equal to 30 wt %, or greater than or equal to 1 wt % and less than or equal to 20 wt %). Other ranges are also possible. In embodiments in which adhesive is present at more than one location, each location at which adhesive is present may independently comprise an adhesive comprising a small molecule crosslinker and/or crosslinks that are reaction products thereof in one or more of the amounts described above.

The adhesive and/or any small molecule crosslinkers therein may be capable of undergoing a crosslinking reaction at any suitable temperature and/or may have undergone a crosslinking reaction at any suitable temperature. In some embodiments, an adhesive may be capable of undergoing a cross-linking reaction and/or may have undergone a crosslinking reaction at a temperature of greater than or equal to 24° C., greater than or equal to 40° C., greater than or equal to 50° C., greater than or equal to 60° C., greater than or equal to 70° C., greater than or equal to 80° C., greater than or equal to 90° C., greater than or equal to 100° C., greater than or equal to 110° C., greater than or equal to 120° C., greater than or equal to 130° C., or greater than or equal to 140° C. In some embodiments, an adhesive may be capable of undergoing a cross-linking reaction and/or may have undergone a crosslinking reaction at a temperature of less than or equal to 150° C., less than or equal to 140° C., less than or equal to 130° C., less than or equal to 120° C., less than or equal to 110° C., less than or equal to 100° C., less than or equal to 90° C., less than or equal to 80° C., less than or equal to 70° C., less than or equal to 60° C., less than or equal to 50° C., or less than or equal to 40° C. Combinations of the above-referenced ranges are also possible (e.g., greater than or equal to 25° C. and less than or equal to 150° C., or greater than or equal to 25° C. and less than or equal to 130° C.). Other ranges are also possible. In embodiments in which adhesive is present at more than one location, each location at which adhesive is present may independently comprise an adhesive capable of undergoing a crosslinking reaction and/or may have undergone a crosslinking reaction at a temperature in one or more of the ranges described above.

When present, an adhesive may comprise a solvent and/or may be formed from a composition comprising a solvent (e.g., from which the solvent has evaporated). By way of example, some embodiments relate to an adhesive applied to the layer or filter media while dissolved or suspended in a solvent. Non-limiting examples of suitable solvents include water, hydrocarbon solvents, ketones, aromatic solvents, fluorinated solvents, toluene, heptane, acetone, n-butyl acetate, methyl ethyl ketone, methylene chloride, naphtha, and mineral spirits. In embodiments in which adhesive is present at more than one location, each location at which adhesive is present may independently comprise one or more of the solvents described above and/or may be formed from a composition comprising one or more of the solvents described above.

When present, an adhesive may have a relatively low glass transition temperature. In some embodiments, an adhesive has a glass transition temperature of less than or equal to 60° C., less than or equal to 50° C., less than or equal to 45° C., less than or equal to 40° C., less than or equal to 35° C., less than or equal to 30° C., less than or equal to 25° C., less than or equal to 24° C., less than or equal to 20° C., less than or equal to 15° C., less than or equal to 10° C., less than or equal to 5° C., less than or equal to 0° C., less than or equal to −5° C., less than or equal to −10° C., less than or equal to −20° C., less than or equal to −30° C., less than or equal to −40° C., less than or equal to −50° C., less than or equal to −60° C., less than or equal to −70° C., less than or equal to −80° C., less than or equal to −90° C., less than or equal to −100° C., or less than or equal to −110° C. In some embodiments, an adhesive has a glass transition temperature of greater than or equal to −125° C., greater than or equal to −110° C., greater than or equal to −100° C., greater than or equal to −90° C., greater than or equal to −80° C., greater than or equal to −70° C., greater than or equal to −60° C., greater than or equal to −50° C., greater than or equal to −40° C., greater than or equal to −30° C., greater than or equal to −20° C., greater than or equal to −10° C., greater than or equal to 0° C., greater than or equal to 5° C., greater than or equal to 10° C., greater than or equal to 24° C., greater than or equal to 25° C., greater than or equal to 40° C., or greater than or equal to 50° C. Combinations of the above-referenced ranges are also possible (e.g., greater than or equal to −125° C. and less than or equal to 60° C., or greater than or equal to −100° C. and less than or equal to 25° C.). Other ranges are also possible. The value of the glass transition temperature for an adhesive may be measured by differential scanning calorimetry as described above. In embodiments in which adhesive is present at more than one location, each location at which adhesive is present may independently comprise an adhesive having a glass transition temperature in one or more of the ranges described above.

When present, an adhesive may have a variety of suitable molecular weights. In some embodiments, an adhesive has a number average molecular weight of greater than or equal to 10 kDa, greater than or equal to 30 kDa, greater than or equal to 50 kDa, greater than or equal to 100 kDa, greater than or equal to 300 kDa, greater than or equal to 500 kDa, greater than or equal to 1000 kDa, greater than or equal to 2000 kDa, or greater than or equal to 3000 kDa. In some embodiments, an adhesive has a number average molecular weight of less than or equal to 5000 kDa, less than or equal to 4000 kDa, less than or equal to 3000 kDa, less than or equal to 1000 kDa, less than or equal to 500 kDa, less than or equal to 300 kDa, less than or equal to 100 kDa, less than or equal to 50 kDa, or less than or equal to 30 kDa. Combinations of the above-referenced ranges are also possible (e.g., greater than or equal to 10 kDa and less than or equal to 5000 kDa, or greater than or equal to 30 kDa and less than or equal to 3000 kDa). Other ranges are also possible. The number average molecular weight may be measured by light scattering. In embodiments in which adhesive is present at more than one location, each location at which adhesive is present may independently comprise an adhesive having a molecular weight in one or more of the ranges described above.

When present, an adhesive may have a variety of suitable basis weights. In some embodiments, an adhesive has a basis weight of greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, an adhesive has a basis weight of less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible. In embodiments in which adhesive is present at more than one location, each location at which adhesive is present may independently comprise an adhesive having a basis weight in one or more of the ranges described above.

In embodiments where the filter media comprises one or more adhesives, the total basis weight of the adhesives in the filter media together (i.e., the sum of the basis weights of the adhesive at each location) may be greater than or equal to 0.05 gsm, greater than or equal to 0.1 gsm, greater than or equal to 0.2 gsm, greater than or equal to 0.5 gsm, greater than or equal to 1 gsm, greater than or equal to 2 gsm, or greater than or equal to 5 gsm. In some embodiments, the total basis weight of the adhesives in the filter media together may be less than or equal to 10 gsm, less than or equal to 5 gsm, less than or equal to 2 gsm, less than or equal to 1 gsm, less than or equal to 0.5 gsm, less than or equal to 0.2 gsm, or less than or equal to 0.1 gsm. Combinations of the above-referenced ranges are also possible (e.g., greater than or equal to 0.05 gsm and less than or equal to 10 gsm, or greater than or equal to 0.1 gsm and less than or equal to 5 gsm). Other ranges are also possible.

When present, an adhesive may adhere together two or more layers between which it is positioned. The strength of adhesion between the two layers may be relatively high. For instance, an adhesive may adhere two layers together with a bond strength of greater than or equal to 100 g/in², greater than or equal to 150 g/in², greater than or equal to 200 g/in², greater than or equal to 500 g/in², greater than or equal to 750 g/in², greater than or equal to 1000 g/in², greater than or equal to 1250 g/in², greater than or equal to 1500 g/in², greater than or equal to 1750 g/in², greater than or equal to 2000 g/in², greater than or equal to 2250 g/in², greater than or equal to 2500 g/in², greater than or equal to 2750 g/in², greater than or equal to 3000 g/in², greater than or equal to 3250 g/in², greater than or equal to 3500 g/in², greater than or equal to 3750 g/in², greater than or equal to 4000 g/in², greater than or equal to 4250 g/in², greater than or equal to 4500 g/in², or greater than or equal to 4750 g/in². In some embodiments, an adhesive adheres two layers together with a bond strength of less than or equal to 5000 g/in², less than or equal to 4750 g/in², less than or equal to 4500 g/in², less than or equal to 4250 g/in², less than or equal to 4000 g/in², less than or equal to 3750 g/in², less than or equal to 3500 g/in², less than or equal to 3250 g/in², less than or equal to 3000 g/in², less than or equal to 2750 g/in², less than or equal to 2500 g/in², less than or equal to 2250 g/in², less than or equal to 2000 g/in², less than or equal to 1750 g/in², less than or equal to 1500 g/in², less than or equal to 1250 g/in², less than or equal to 1000 g/in², less than or equal to 750 g/in², less than or equal to 500 g/in², less than or equal to 200 g/in², or less than or equal to 150 g/in². Combinations of the above-referenced ranges are also possible (e.g., greater than or equal to 100 g/in² and less than or equal to 5000 g/in², or greater than or equal to 150 g/in² and less than or equal to 3000 g/in²). Other ranges are also possible. In embodiments in which adhesive is present at more than one location, each location at which adhesive is present may independently comprise an adhesive adhering together two layers with a bond strength in one or more of the ranges described above. In some embodiments, the entire filter media as a whole has an internal bond strength in one or more ranges described above. The bond strength of the entire filter media as a whole is equivalent to the weakest bond strength between two layers of the media.

The bond strength (e.g., internal bond strength) between two layers (e.g., between two layers adhered together by an adhesive) may be determined by using a z-directional peel strength test. In short, the bond strength may be determined by the following procedure. First, a 1″×1″ sample is mounted on a steel block with dimensions 1″×1″×0.5″ using double sided tape. The sample block is then mounted onto the non-traversing head of a tensile tester and another steel block of the same size is connected to the traversing head with double sided tape. The traversing head is brought down and bonded to the sample on the steel block of the non-traversing head. Enough pressure is applied so that the steel blocks are bonded together via the mounted sample. The traversing head is then moved at a traversing speed of 1″/min and the maximum load is found from the peak of a stress-strain curve. The bond strength (e.g., internal bond strength) between the two layers is considered to be equivalent to the maximum load measured by this procedure.

A filter media described herein may have any of a variety of suitable basis weights. In some embodiments, a filter media has a basis weight of greater than or equal to 5 gsm, greater than or equal to 10 gsm, greater than or equal to 20 gsm, greater than or equal to 40 gsm, greater than or equal to 60 gsm, greater than or equal to 80 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, greater than or equal to 500 gsm, greater than or equal to 600 gsm, greater than or equal to 700 gsm, greater than or equal to 800 gsm, greater than or equal to 900 gsm, greater than or equal to 1000 gsm, greater than or equal to 1100 gsm, greater than or equal to 1200 gsm, greater than or equal to 1300 gsm, or greater than or equal to 1400 gsm. In some embodiments, a filter media has a basis weight of less than or equal to 1500 gsm, less than or equal to 1400 gsm, less than or equal to 1300 gsm, less than or equal to 1200 gsm, less than or equal to 1100 gsm, less than or equal to 1000 gsm, less than or equal to 900 gsm, less than or equal to 800 gsm, less than or equal to 700 gsm, less than or equal to 600 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 80 gsm, less than or equal to 60 gsm, less than or equal to 40 gsm, less than or equal to 20 gsm, or less than or equal to 10 gsm. Combinations of these ranges are also possible (e.g., greater than or equal to 5 gsm and less than or equal to 1500 gsm, greater than or equal to 5 gsm and less than or equal to 1000 gsm, or greater than or equal to 10 gsm and less than or equal to 500 gsm). Other ranges are also possible.

The basis weight of a filter media may be determined in accordance with ISO 536:2012.

A filter media described herein may have any of a variety of suitable dust holding capacities. In some embodiments, a filter media has a dust holding capacity of greater than or equal to 1 gsm, greater than or equal to 5 gsm, greater than or equal to 10 gsm, greater than or equal to 20 gsm, greater than or equal to 50 gsm, greater than or equal to 80 gsm, greater than or equal to 100 gsm, greater than or equal to 150 gsm, greater than or equal to 200 gsm, greater than or equal to 250 gsm, greater than or equal to 300 gsm, greater than or equal to 350 gsm, greater than or equal to 400 gsm, greater than or equal to 450 gsm, greater than or equal to 500 gsm, greater than or equal to 550 gsm, greater than or equal to 600 gsm, or greater than or equal to 650 gsm. In some embodiments, aa filter media has a dust holding capacity of less than or equal to 700 gsm, less than or equal to 650 gsm, less than or equal to 600 gsm, less than or equal to 550 gsm, less than or equal to 500 gsm, less than or equal to 450 gsm, less than or equal to 400 gsm, less than or equal to 350 gsm, less than or equal to 300 gsm, less than or equal to 250 gsm, less than or equal to 200 gsm, less than or equal to 150 gsm, less than or equal to 100 gsm, less than or equal to 80 gsm, less than or equal to 50 gsm, less than or equal to 20 gsm, less than or equal to 10 gsm, or less than or equal to 5 gsm. Combinations of these ranges are also possible (e.g., greater than or equal to 1 gsm and less than or equal to 700 gsm, greater than or equal to 1 gsm and less than or equal to 500 gsm, or greater than or equal to 10 gsm and less than or equal to 450 gsm). Other ranges are also possible.

The dust holding capacity may be measured according to ISO 16889 (2008), (modified by testing a flat sheet sample) on a Multipass Filter Test Stand manufactured by FTI. The measurement may comprise using Aviation Hydraulic Fluid AERO HFA MIL H-5606A manufactured by Mobil in which ISO medium test dust (A3) is dispersed at a 10 mg/L BUGL. The Aviation Hydraulic Fluid may be passed through the surface-treated fiber web at a face velocity of 1.7 L/min, and the dust holding capacity may be measured when the pressure drop across the fiber web reaches 200 kPa above the initial pressure drop.

The filter media have any suitable thickness. For example, in some embodiments, the filter media has a thickness of greater than or equal to 0.01 mm, greater than or equal to 0.1 mm, greater than or equal to 0.05 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 15 mm, greater than or equal to 20 mm, or greater than or equal to 25 mm. In certain embodiments, the filter media has a thickness of less than or equal to 30 mm, less than or equal to 28 mm, less than or equal to 25 mm, less than or equal to 23 mm, less than or equal to 20 mm, less than or equal to 18 mm, less than or equal to 15 mm, less than or equal to 13 mm, less than or equal to 10 mm, less than or equal to 9 mm, less than or equal to 8 mm, less than or equal to 7 mm, less than or equal to 6 mm, less than or equal to 5 mm, less than or equal to 4 mm, less than or equal to 3 mm, less than or equal to 2 mm, or less than or equal to 1 mm. Combinations of these ranges are also possible (e.g., greater than or equal to 0.01 mm and less than or equal to 30 mm or greater than or equal to 0.1 mm and less than or equal to 20 mm). Other ranges are also possible.

The thickness of a filter media may be determined in accordance with ISO 534 (2011) at 2 N/cm².

The filter media may have any suitable mean flow pore size. For example, in some cases, the filter media has a mean flow pore size of greater than or equal to 0.001 microns, greater than or equal to 0.01 microns, greater than or equal to 0.1 microns, greater than or equal to 0.3 microns, greater than or equal to 0.5 microns, greater than or equal to 0.7 microns, greater than or equal to 1 micron, greater than or equal to 2 microns, greater than or equal to 3 microns, greater than or equal to 5 microns, greater than or equal to 7 microns, greater than or equal to 10 microns, greater than or equal to 15 microns, greater than or equal to 20 microns, greater than or equal to 30 microns, greater than or equal to 40 microns, greater than or equal to 50 microns, greater than or equal to 60 microns, greater than or equal to 70 microns, greater than or equal to 80 microns, or greater than or equal to 90 microns. In certain instances, the filter media has a mean flow pore size of less than or equal to 100 microns, less than or equal to 95 microns, less than or equal to 90 microns, less than or equal to 85 microns, less than or equal to 80 microns, less than or equal to 75 microns, less than or equal to 70 microns, less than or equal to 65 microns, less than or equal to 60 microns, less than or equal to 55 microns, less than or equal to 50 microns, less than or equal to 40 microns, less than or equal to 30 microns, less than or equal to 20 microns, less than or equal to 15 microns, less than or equal to 10 microns, less than or equal to 7 microns, less than or equal to 5 microns, less than or equal to 3 microns, less than or equal to 2 microns, or less than or equal to 1 micron. Combinations of these ranges are also possible (e.g., greater than or equal to 0.001 microns and less than or equal to 100 microns, greater than or equal to 0.01 microns and less than or equal to 50 microns, or greater than or equal to 0.01 microns and less than or equal to 20 microns). Other ranges are also possible.

The mean flow pore size of a filter media may be determined in accordance with ASTM F-316 (2003).

The filter media may have any suitable total Gurley bending stiffness (e.g., in the machine direction and/or in the cross direction). For example, in some cases, the filter media has a total Gurley bending stiffness (e.g., in the machine direction and/or in the cross direction) of greater than or equal to 1 mg, greater than or equal to 5 mg, greater than or equal to 10 mg, greater than or equal to 15 mg, greater than or equal to 20 mg, greater than or equal to 25 mg, greater than or equal to 50 mg, greater than or equal to 75 mg, greater than or equal to 100 mg, greater than or equal to 150 mg, greater than or equal to 200 mg, greater than or equal to 300 mg, greater than or equal to 400 mg, greater than or equal to 500 mg, greater than or equal to 750 mg, greater than or equal to 1000 mg, greater than or equal to 1500 mg, greater than or equal to 2000 mg, greater than or equal to 2500 mg, or greater than or equal to 3000 mg. In certain embodiments, the filter media has a total Gurley bending stiffness (e.g., in the machine direction and/or in the cross direction) of less than or equal to 3500 mg, less than or equal to 3250 mg, less than or equal to 3000 mg, less than or equal to 2750 mg, less than or equal to 2500 mg, less than or equal to 2250 mg, less than or equal to 2000 mg, less than or equal to 1500 mg, less than or equal to 1000 mg, less than or equal to 750 mg, less than or equal to 500 mg, less than or equal to 400 mg, less than or equal to 300 mg, less than or equal to 200 mg, or less than or equal to 150 mg. Combinations of these ranges are also possible (e.g., greater than or equal to 1 mg and less than or equal to 3500 mg, greater than or equal to 10 mg and less than or equal to 3000 mg, or greater than or equal to 25 mg and less than or equal to 3000 mg). Other ranges are also possible.

The total Gurley bending stiffness of a filter media may be determined (e.g., in the machine direction and/or in the cross direction) in accordance with T543 om-94.

The filter media may have any suitable gamma (e.g., at the most penetrating particle size (MPPS) or at 0.09 microns). For example, in some cases, the filter media has a gamma (e.g., at the MPPS or at 0.09 microns) of greater than or equal to 3, greater than or equal to 4, greater than or equal to 5, greater than or equal to 6, greater than or equal to 7, greater than or equal to 8, greater than or equal to 9, greater than or equal to 10, greater than or equal to 12, greater than or equal to 15, greater than or equal to 20, greater than or equal to 25, greater than or equal to 30, greater than or equal to 40, greater than or equal to 50, greater than or equal to 75, greater than or equal to 100, greater than or equal to 125, greater than or equal to 150, greater than or equal to 200, or greater than or equal to 250. In certain instances, the filter media has a gamma (e.g., at the MPPS or at 0.09 microns) of less than or equal to 400, less than or equal to 375, less than or equal to 350, less than or equal to 325, less than or equal to 300, less than or equal to 275, less than or equal to 250, less than or equal to 200, less than or equal to 150, less than or equal to 125, less than or equal to 100, less than or equal to 75, less than or equal to 50, less than or equal to 40, less than or equal to 30, or less than or equal to 25. Combinations of these ranges are also possible (e.g., greater than or equal to 3 and less than or equal to 300 or greater than or equal to 4 and less than or equal to 300). Other ranges are also possible.

Gamma is defined by the following formula: Gamma=(−log₁₀(penetration %/100)/(average pressure drop, mm H₂O)×100. Penetration, often expressed as a percentage, is defined as follows: Pen (%)=(C/C₀)*100 where C is the particle concentration after passage through the filter and C₀ is the particle concentration before passage through the filter. Penetration (and gamma) may be measured at any desired particle size (e.g., MPPS or 0.09 microns). MPPS penetration is the penetration of the most penetrating particle size; in other words, when penetration is measured for a range of particle sizes, the MPPS penetration is the value of penetration measured for the particle with the highest penetration. Penetration (e.g., MPPS penetration) and average pressure drop can be measured for any particle size using the EN1822:2009 standard for air filtration, which is described below. Penetration and average pressure drop may be measured by blowing dioctyl phthalate (DOP) particles through a filter media and measuring the percentage of particles that penetrate therethrough and the pressure drop as the particles are blown through the filter media. This may be accomplished by use of a TSI 3160 automated filter testing unit from TSI, Inc. equipped with a dioctyl phthalate generator for DOP aerosol testing based on the EN1822:2009 standard for MPPS DOP particles. The TSI 3160 automated filter testing unit is employed to sequentially blow populations of DOP particles with varying average particle diameters at a 100 cm² face area of the upstream face of the filter media. The populations of particles are blown at the upstream face of the filter media in order of increasing average diameter, where each has a geometric standard deviation of less than 1.3, and they have the following set of average diameters: 0.04 microns, 0.08 microns, 0.12 microns, 0.16 microns, 0.2 microns, 0.26 microns, and 0.3 microns. The penetration and average pressure drop is measured continuously and separately for each population of particles over the period of time during which that population of particles is blown at the upstream face of the filter media. The upstream and downstream particle concentrations are measured by use of condensation particle counters. During the penetration measurement, the 100 cm² face area of the upstream face of the filter media is subjected to a continuous loading of DOP particles at an airflow of 12 L/min, giving a media face velocity of 2 cm/s. Each population of particles is blown at the upstream face of the filter media for 120 s or such that at least 1000 particles are counted downstream of the filter media, whichever is longer.

To determine the MPPS penetration, the instrument measures a penetration value across the filter media (or layer) by determining the DOP particle size at which the highest level of penetration was measured for the test, i.e., the most penetrating particle size (MPPS). The sample is exposed to particles of each size sequentially. The penetration of the particles as a function of particle size is plotted, and the data is fit with a parabolic function. Then, the maximum of the parabolic function is found; the particle size at the maximum is the MPPS and the penetration at the maximum is the penetration at the MPPS.

The filter media may have any suitable air permeability. For example, in some embodiments, the filter media has an air permeability of greater than or equal to 0.2 CFM, greater than or equal to 0.5 CFM, greater than or equal to 1 CFM, greater than or equal to 2 CFM, greater than or equal to 5 CFM, greater than or equal to 10 CFM, greater than or equal to 20 CFM, greater than or equal to 30 CFM, greater than or equal to 40 CFM, greater than or equal to 50 CFM, greater than or equal to 75 CFM, greater than or equal to 100 CFM, greater than or equal to 125 CFM, greater than or equal to 150 CFM, greater than or equal to 175 CFM, greater than or equal to 200 CFM, greater than or equal to 250 CFM, greater than or equal to 300 CFM, greater than or equal to 400 CFM, greater than or equal to 500 CFM, greater than or equal to 600 CFM, greater than or equal to 700 CFM, or greater than or equal to 800 CFM. In certain embodiments, the filter media has an air permeability of less than or equal to 1000 CFM, less than or equal to 900 CFM, less than or equal to 800 CFM, less than or equal to 700 CFM, less than or equal to 600 CFM, less than or equal to 500 CFM, less than or equal to 400 CFM, less than or equal to 300 CFM, less than or equal to 250 CFM, less than or equal to 200 CFM, less than or equal to 175 CFM, less than or equal to 150 CFM, less than or equal to 125 CFM, less than or equal to 100 CFM, less than or equal to 75 CFM, less than or equal to 50 CFM, less than or equal to 40 CFM, or less than or equal to 30 CFM. Combinations of these ranges are also possible (e.g., greater than or equal to 0.2 CFM and less than or equal to 1000 CFM or greater than or equal to 0.5 CFM and less than or equal to 800 CFM). Other ranges are also possible.

The air permeability of a filter media may be determined in accordance with ASTM D737-04 (2016) at a pressure of 125 Pa.

The filter media may have any suitable efficiency (e.g., initial efficiency). For example, in certain embodiments, the filter media has an efficiency (e.g., initial efficiency) of greater than or equal to 1%, greater than or equal to 2%, greater than or equal to 5%, greater than or equal to 10%, greater than or equal to 20%, greater than or equal to 30%, greater than or equal to 40%, greater than or equal to 50%, greater than or equal to 60%, greater than or equal to 70%, greater than or equal to 80%, greater than or equal to 85%, greater than or equal to 90%, greater than or equal to 95%, greater than or equal to 97%, greater than or equal to 98%, greater than or equal to 99%, greater than or equal to 99.9%, greater than or equal to 99.99%, greater than or equal to 99.999%, greater than or equal to 99.9999%, or greater than or equal to 99.99999%. In some embodiments, the filter media has an efficiency of less than 100%, less than or equal to 99.99999%, less than or equal to 99.9999%, less than or equal to 99.999%, less than or equal to 99.99%, less than or equal to 99.9%, less than or equal to 99.5%, less than or equal to 99%, less than or equal to 98%, less than or equal to 97%, less than or equal to 95%, less than or equal to 90%, less than or equal to 85%, or less than or equal to 80%. Combinations of these ranges are also possible (e.g., greater than or equal to 1% and less than 100%, greater than or equal to 2% and less than or equal to 99.99999%, or greater than or equal to 5% and less than or equal to 99.99999%). Other ranges are also possible.

Efficiency may be determined by the following equation: Efficiency (%)=100-penetration (%), wherein penetration is determined at any particle size (e.g., at 0.09 microns) as described above.

The filter media may have any suitable salt (e.g., NaCl) loading capacity. For example, in some instances, the filter media has a salt (e.g., NaCl) loading capacity of greater than or equal to 0.1 g/m², greater than or equal to 0.3 g/m², greater than or equal to 0.5 g/m², greater than or equal to 0.7 g/m², greater than or equal to 1 g/m², greater than or equal to 2 g/m², greater than or equal to 3 g/m², greater than or equal to 4 g/m², greater than or equal to 5 g/m², greater than or equal to 6 g/m², greater than or equal to 7 g/m², greater than or equal to 8 g/m², greater than or equal to 9 g/m², greater than or equal to 10 g/m², greater than or equal to 12 g/m², greater than or equal to 15 g/m², greater than or equal to 20 g/m², greater than or equal to 25 g/m², greater than or equal to 30 g/m², or greater than or equal to 35 g/m². In certain cases, the filter media has a salt (e.g., NaCl) loading capacity of less than or equal to 40 g/m², less than or equal to 38 g/m², less than or equal to 35 g/m², less than or equal to 33 g/m², less than or equal to 30 g/m², less than or equal to 28 g/m², less than or equal to 25 g/m², less than or equal to 20 g/m², less than or equal to 15 g/m², less than or equal to 10 g/m², less than or equal to 5 g/m², less than or equal to 4 g/m², less than or equal to 3 g/m², less than or equal to 2 g/m², or less than or equal to 1 g/m². Combinations of these ranges are also possible (e.g., greater than or equal to 0.1 g/m² and less than or equal to 40 g/m² or greater than or equal to 0.5 g/m² and less than or equal to 30 g/m²). Other ranges are also possible.

The salt (e.g., NaCl) loading capacity of the filter media may be determined by exposing a filter media with a nominal exposed area of 100 cm² to salt (e.g., NaCl) particles with a median diameter of 0.26 microns at a concentration of 15 mg/m³ and a face velocity of 5.3 cm/second. Salt (e.g., NaCl) loading may be determined using an 8130 CertiTest™ automated filter testing unit from TSI, Inc. equipped with a salt (e.g., NaCl) generator. The average particle size created by the salt particle generator is 0.26 micron mass mean diameter. The 8130 is run in a continuous mode with one pressure drop reading approximately every minute. The test is run using a 100 cm² filter media sample at a flow rate of 32 liters per minute (face velocity of 5.3 cm/sec) containing 15 mg/m³ of salt (e.g., NaCl) until the pressure drop across the filter media increases by 250 Pa. The salt (e.g., NaCl) loading capacity is determined by weighing the filter media both prior to and after the test and dividing the measured increase in mass by the area of the filter media to obtain the salt (e.g., NaCl) loading capacity per unit area of the filter media.

The filter media may have any suitable DOP oil loading capacity. For example, in certain embodiments, the filter media has a DOP oil loading capacity of greater than or equal to 1 g/m², greater than or equal to 2 g/m², greater than or equal to 3 g/m², greater than or equal to 4 g/m², greater than or equal to 5 g/m², greater than or equal to 7 g/m², greater than or equal to 10 g/m², greater than or equal to 12 g/m², greater than or equal to 15 g/m², greater than or equal to 20 g/m², greater than or equal to 30 g/m², greater than or equal to 40 g/m², greater than or equal to 50 g/m², greater than or equal to 60 g/m², or greater than or equal to 70 g/m². In some embodiments, the filter media has a DOP oil loading capacity of less than or equal to 80 g/m², less than or equal to 75 g/m², less than or equal to 70 g/m², less than or equal to 65 g/m², less than or equal to 60 g/m², less than or equal to 55 g/m², less than or equal to 50 g/m², less than or equal to 40 g/m², less than or equal to 30 g/m², less than or equal to 20 g/m², less than or equal to 15 g/m², less than or equal to 12 g/m², less than or equal to 10 g/m², less than or equal to 7 g/m², or less than or equal to 6 g/m². Combinations of these ranges are also possible (e.g., greater than or equal to 1 g/m² and less than or equal to 80 g/m², greater than or equal to 3 g/m² and less than or equal to 70 g/m², or greater than or equal to 4 g/m² and less than or equal to 70 g/m²). Other ranges are also possible.

In general, the DOP oil loading process is performed by exposing a 100 cm² test area of a filter media to an aerosol of DOP particles at a concentration of between 80 and 100 mg/m³, a flow rate of 32 L/minute, and a face velocity of 5.32 cm/second. The DOP particles are produced by a TDA 100P aerosol generator available from Air Techniques International and have a 0.18 micron count median diameter, a 0.3 micron mass mean diameter, and a geometric standard deviation of less than 1.6 microns. Different filter media properties may be determined during DOP oil loading either continuously or by pausing the DOP oil loading to make one or more measurements, depending on the particular test. For example, the pressure drop across the filter media as a function of DOP oil loading may be measured continuously. DOP oil loading, or weight of DOP in the filter media per filter media area, may be determined by measuring the pressure drop during DOP oil loading, stopping oil loading once the pressure drop doubles, and then weighing the filter media. Any increase in filter media weight is attributed to DOP oil, and so the DOP oil loading is determined by taking the difference between the measured weight and the initially DOP-free filter media. Other parameters (e.g., penetration at the MPPS, gamma) may also be determined either during or after DOP oil loading by performing measurements as described herein.

In some embodiments, the filter media as a whole (e.g., a filter media that comprises one or more layers having an oleophobic property such as including an oleophobic component, one or more layers having an oil rank of greater than or equal to 1, and/or one or more surface-modified layers) may perform particularly well after undergoing a DOP oil loading process. Such performance characteristics may include the filter media having a relatively low pressure drop after undergoing the DOP oil loading process, having a relatively low change in the pressure drop after undergoing the DOP oil loading process in comparison to the same media prior to the DOP oil loading process, having a relatively low penetration at the MPPS after undergoing the DOP oil loading process, having a relatively low change in the penetration at the MPPS after undergoing the DOP oil loading process in comparison to the same media prior to the DOP oil loading process, having a high value of gamma after undergoing the DOP oil loading process, and/or having a relatively low change in the value of gamma after undergoing the DOP oil loading process in comparison to the same media prior to the DOP oil loading process.

As described above, the surface(s) of surface-treated fiber webs described herein may be treated by any of a variety of suitable techniques. For example, in some embodiments, a surface-treated fiber web is fluid enhanced. Surface-treated fiber webs that are fluid enhanced may have one or more structural features that are indicative of fluid enhancement. Such structural features may comprise cavities and/or entangled fibers (e.g., fibers entangled via the fluid enhancement process). The structural features may be uniform or non-uniform. Similarly, the structural features may be isotropic or anisotropic.

A surface-treated fiber web described herein may be prepared, by fluid enhancing a precursor layer, according to some embodiments. A fluid enhanced surface-treated fiber web and/or layer may be fluid enhanced on a single side or may be fluid enhanced on opposing sides. It is also possible for a filter media to comprise two or more surface-treated fiber webs and/or layers that are fluid enhanced. Such layers may be fluid enhanced separately and then combined together (e.g., via lamination) or may be fluid enhanced after being combined. It is also possible for one or more layers to be fluid enhanced while being formed (e.g., during wet laying). When two fluid enhanced layers that are each fluid enhanced on exactly one side are combined, both fluid enhanced sides may face each other, face away from each other, or face the same direction. In some embodiments, a filter media comprises exactly one fluid enhanced surface-treated fiber web or layer and/or comprises both a fluid enhanced surface-treated fiber web or layer and a further layer that has not been fluid enhanced.

Fluid enhancement may comprise impinging jets and/or streams of a fluid onto a surface-treated fiber web. In some embodiments, fluid enhancement comprises performing a hydroentangling process (i.e., the fluid may comprise liquid water and the process may cause fibers in the layer to become entangled). It is also possible for fluid enhancement to comprise performing a process that is otherwise-identical to a hydroentangling process but is performed at a pressure too low to cause hydroentangling and/or to comprise performing a process similar to hydroentangling but with a fluid other than liquid water (e.g., a liquid other than water, a gas). Non-limiting examples of suitable such fluids for performing fluid enhancement include liquid water, steam, and compressed air.

The jets and/or streams of fluid employed in a fluid enhancement process may be provided by a variety of suitable sources, such as a hydroentangling apparatus and/or a sprayer. In some embodiments, the jets and/or streams of a fluid comprise droplets (e.g., they may be in the form of a spray). The fluid impinging on the surface-treated fiber web may be relatively pure; for instance, it may be distilled water and/or deionized water. After undergoing fluid enhancement, a surface-treated fiber web may be dried, such as with air dryer. In some embodiments, a surface-treated fiber web is subject to fluid enhancement while being moved laterally. The surface-treated fiber web may be transported on a porous belt, such as a screen or mesh-type conveyor belt. As it is being transported on the porous belt, it may be exposed to the jets and/or streams of fluid, which may be first pressurized by a pump. These jets and/or streams may be stationary and/or may also move. The fluid jets and/or streams may impinge on the surface-treated fiber web and/or penetrate therein. In some embodiments, a vacuum is provided beneath the porous transport belt, which may aid the passage of the fluid through the surface-treated fiber web and/or reduce the amount of time and energy necessary for drying the layer at the conclusion of the fluid enhancement process.

It is also possible for a surface-treated fiber web to undergo fluid enhancement while stationary. In such embodiments, nozzles supplying fluid jets and/or streams may be moved over the surface-treated fiber web at various speeds and/or in various patterns.

In some embodiments, nozzles may be turned on and off during fluid enhancement.

In some embodiments, filter media components such as adsorbent particles, or additional layers are deposited such that they are at least partially disposed on a surface-treated fiber web that has been fluid enhanced.

Careful selection of fluid enhancement process parameters can, in some embodiments, surface-treat a surface of a fiber web to include a plurality of cavities having a favorable morphology, as discussed in greater detail below.

A fluid enhancement process may comprise impinging a jet and/or a stream of fluid having any of a variety of suitable pressures onto a surface-treated fiber web. In some embodiments, a hydroentangling process comprises impinging a jet and/or a stream of fluid having a pressure of greater than or equal to 0.5 bar, greater than or equal to 0.7 bar, greater than or equal to 1 bar, greater than or equal to 1.2 bar, greater than or equal to 1.5 bar, greater than or equal to 2 bar, greater than or equal to 2.5 bar, greater than or equal to 3 bar, greater than or equal to 5 bar, greater than or equal to 10 bar, greater than or equal to 15 bar, greater than or equal to 20 bar, greater than or equal to 25 bar, greater than or equal to 30 bar, greater than or equal to 35 bar, or greater than or equal to 40 bar, onto a surface-treated fiber web. In some embodiments, a fluid enhancement process comprises impinging a jet and/or a stream of fluid having a pressure of less than or equal to 50 bar, less than or equal to 40 bar, less than or equal to 35 bar, less than or equal to 30 bar, less than or equal to 25 bar, less than or equal to 20 bar, less than or equal to 15 bar, less than or equal to 10 bar, less than or equal to 5 bar, less than or equal to 3 bar, less than or equal to 2.5 bar, less than or equal to 2 bar, less than or equal to 1.5 bar, less than or equal to 1.2 bar, less than or equal to 1 bar, or less than or equal to 0.7 bar onto a surface-treated fiber web. Combinations of the above-referenced ranges are also possible (e.g., greater than or equal to 0.5 bar and less than or equal to 50 bar, greater than or equal to 0.5 bar and less than or equal to 40 bar, or greater than or equal to 0.5 bar and less than or equal to 30 bar, or greater than or equal to 10 bar and less than or equal to 20 bar). Other ranges are also possible.

In some embodiments, each jet and/or stream of fluid may independently have a pressure in one or more ranges described above. The pressures for each pair of jets and/or streams of fluid may be the same or different.

In some embodiments, an apparatus suitable for performing fluid enhancement (e.g., a hydroentangling apparatus) may include a plurality of nozzles configured to spray jets and/or streams of pressurized fluid at a surface-treated fiber web described herein. Similarly, fluid enhancement may comprise impinging jets and/or streams of pressurized fluid onto a layer (e.g., a surface-treated fiber web) from nozzles present in a fluid enhancement apparatus. The plurality of nozzles may have any of a variety of spatial positions with respect to one another. For example, the plurality of nozzles may be arranged one station or in multiple stations. Each station may include exactly one row, or may include a plurality of rows. In some embodiments, the nozzles in a row and/or station are regularly spaced; however, arrangements where some or all of the nozzles are irregularly spaced are also possible. It is also possible for a hydroentangling apparatus to comprise some nozzles that are regularly spaced and some nozzles that are irregularly spaced. It should also be noted that different nozzles and/or different stations may have the same properties (e.g., pressure, nozzle diameter) as other nozzles and/or stations or different properties from other nozzles and/or stations.

In some embodiments, a fluid enhancement apparatus has a nozzle hole number density of greater than or equal to 50 nozzle holes per meter, greater than or equal to 100 nozzle holes per meter, greater than or equal to 150 nozzle holes per meter, greater than or equal to 200 nozzle holes per meter, greater than or equal to 250 nozzle holes per meter, greater than or equal to 300 nozzle holes per meter, greater than or equal to 400 nozzle holes per meter, greater than or equal to 500 nozzle holes per meter, greater than or equal to 700 nozzle holes per meter, greater than or equal to 1000 nozzle holes per meter, greater than or equal to 1500 nozzle holes per meter, greater than or equal to 2000 nozzle holes per meter, greater than or equal to 3000 nozzle holes per meter, greater than or equal to 5000 nozzle holes per meter, greater than or equal to 10000 nozzle holes per meter, greater than or equal to 20000 nozzle holes per meter, greater than or equal to 30000 nozzle holes per meter, greater than or equal to 40000 nozzle holes per meter, greater than or equal to 50000 nozzle holes per meter, greater than or equal to 60000 nozzle holes per meter, greater than or equal to 70000 nozzle holes per meter, greater than or equal to 80000 nozzle holes per meter, greater than or equal to 90000 nozzle holes per meter, greater than or equal to 100000 nozzle holes per meter, greater than or equal to 125000 nozzle holes per meter, greater than or equal to 150000 nozzle holes per meter, or greater than or equal to 175000 nozzle holes per meter. In some embodiments, a fluid enhancement apparatus has a nozzle number density of less than or equal to 200000 nozzle holes per meter, less than or equal to 175000 nozzle holes per meter, less than or equal to 150000 nozzle holes per meter, less than or equal to 125000 nozzle holes per meter, less than or equal to 100000 nozzle holes per meter, less than or equal to 90000 nozzle holes per meter, less than or equal to 80000 nozzle holes per meter, less than or equal to 70000 nozzle holes per meter, less than or equal to 60000 nozzle holes per meter, less than or equal to 50000 nozzle holes per meter, less than or equal to 40000 nozzle holes per meter, less than or equal to 30000 nozzle holes per meter, less than or equal to 20000 nozzle holes per meter, less than or equal to 10000 nozzle holes per meter, less than or equal to 5000 nozzle holes per meter, less than or equal to 3000 nozzle holes per meter, less than or equal to 2000 nozzle holes per meter, less than or equal to 1500 nozzle holes per meter, less than or equal to 1000 nozzle holes per meter, less than or equal to 700 nozzle holes per meter, less than or equal to 500 nozzle holes per meter, less than or equal to 400 nozzle holes per meter, less than or equal to 300 nozzle holes per meter, less than or equal to 250 nozzle holes per meter, less than or equal to 200 nozzle holes per meter, less than or equal to 150 nozzle holes per meter, or less than or equal to 100 nozzle holes per meter. Combinations of the above-referenced ranges are also possible (e.g., greater than or equal to 50 nozzle holes per meter and less than or equal to 150000 nozzle holes per meter, greater than or equal to 100 nozzle holes per meter and less than or equal to 100000 nozzle holes per meter, or greater than or equal to 200 nozzle holes per meter and less than or equal to 50000 nozzle holes per meter). Other ranges are also possible.

A fluid enhancement apparatus (e.g., a hydroentangling apparatus) described herein may comprise nozzles with any of a variety of suitable nozzle hole diameters. Additionally, fluid enhancement may comprise impinging jets and/or streams of pressurized fluid onto a layer (e.g., a surface-treated fiber web) from nozzles present in a fluid enhancement apparatus. In some embodiments, a fluid enhancement apparatus comprises nozzles with a nozzle hole diameter of greater than or equal to 1 micron, greater than or equal to 5 microns, greater than or equal to 10 microns, greater than or equal to 20 microns, greater than or equal to 30 microns, greater than or equal to 40 microns, greater than or equal to 50 microns, greater than or equal to 75 microns, greater than or equal to 100 microns, greater than or equal to 150 microns, greater than or equal to 200 microns, greater than or equal to 250 microns, greater than or equal to 300 microns, greater than or equal to 350 microns, greater than or equal to 400 microns, greater than or equal to 500 microns, greater than or equal to 600 microns, greater than or equal to 700 microns, greater than or equal to 800 microns, or greater than or equal to 900 microns. In some embodiments, a fluid enhancement apparatus comprises nozzles with a nozzle hole diameter of less than or equal to 1000 microns, less than or equal to 900 microns, less than or equal to 800 microns, less than or equal to 700 microns, less than or equal to 600 microns, less than or equal to 500 microns, less than or equal to 400 microns, less than or equal to 350 microns, less than or equal to 300 microns, less than or equal to 250 microns, less than or equal to 200 microns, less than or equal to 150 microns, less than or equal to 100 microns, less than or equal to 75 microns, less than or equal to 50 microns, less than or equal to 40 microns, less than or equal to 30 microns, less than or equal to 20 microns, less than or equal to 10 microns, or less than or equal to 5 microns. Combinations of the above-referenced ranges are also possible (e.g., greater than or equal to 1 micron and less than or equal to 1000 microns, greater than or equal to 5 microns and less than or equal to 500 microns, or greater than or equal to 50 microns and less than or equal to 300 microns). Other ranges are also possible.

In some embodiments, each of the plurality of nozzles in a fluid enhancement apparatus may independently have a nozzle hole diameter in one or more ranges described above. The diameters for each pair of nozzles may be the same or different.

In embodiments where a surface-treated fiber web undergoing fluid enhancement is being translated (e.g., a surface-treated fiber web), the surface-treated fiber web may be translated at any suitable speed. In some embodiments, the surface-treated fiber web may be translated at a speed of greater than or equal to 1 m/min, greater than or equal to 2 m/min, greater than or equal to 3 m/min, greater than or equal to 4 m/min, greater than or equal to 5 m/min, greater than or equal to 10 m/min, greater than or equal to 20 m/min, greater than or equal to 30 m/min, greater than or equal to 40 m/min, greater than or equal to 50 m/min, greater than or equal to 75 m/min, greater than or equal to 100 m/min, greater than or equal to 150 m/min, greater than or equal to 200 m/min, greater than or equal to 250 m/min, greater than or equal to 300 m/min, greater than or equal to 400 m/min, greater than or equal to 500 m/min, greater than or equal to 750 m/min, greater than or equal to 1000 m/min, greater than or equal to 1500 m/min, or greater than or equal to 2000 m/min. In some embodiments, a surface-treated fiber web undergoing fluid enhancement is translated at a speed of less than or equal to 2500 m/min, less than or equal to 2000 m/min, less than or equal to 1500 m/min, less than or equal to 1000 m/min, less than or equal to 750 m/min, less than or equal to 500 m/min, less than or equal to 400 m/min, less than or equal to 300 m/min, less than or equal to 250 m/min, less than or equal to 200 m/min, less than or equal to 150 m/min, less than or equal to 100 m/min, less than or equal to 75 m/min, less than or equal to 50 m/min, less than or equal to 40 m/min, less than or equal to 30 m/min, less than or equal to 20 m/min, less than or equal to 10 m/min, less than or equal to 5 m/min, less than or equal to 4 m/min, less than or equal to 3 m/min, or less than or equal to 2 m/min. Combinations of the above-referenced ranges are also possible (e.g., greater than or equal to 1 m/min and less than or equal to 2500 m/min, greater than or equal to 2 m/min and less than or equal to 500 m/min, or greater than or equal to 3 m/min and less than or equal to 150 m/min). Other ranges are also possible.

The filter media described herein may be suitable for any of a variety of applications. In some embodiments, the filter media is an air filter. For example, in certain cases, the filter media is a high efficiency particulate air (HEPA) or ultra-low penetration air (ULPA) filter. In some embodiments the filter media is a cabin filter (e.g., of an air cabin). According to some embodiments, the filter media described is part of respiratory protective equipment, such as a face mask (e.g., a pleated face mask), a ventilator, and/or a powered respiratory protective equipment (PRPE). The filter media may be a used in a gas turbine filter, in some embodiments. In some embodiments, the filter media is used in a clean room (e.g., to remove airborne molecular contamination (AMC)). In some embodiments, the filter media is used in a fuel cell. According to some embodiments, the filter media is used for HVAC filtration. Filter media comprising adsorbent particles may be particularly useful for use in clean rooms (e.g., to remove AMC), in fuel cells, and for room air purification.

The following examples are intended to illustrate certain embodiments of the present disclosure, but do not exemplify the full scope of the disclosure.

### Example 1

This example demonstrates improvements in topography that resulted from the surface treatment of a fiber web suitable for use as a backer layer of a filter media in a non-limiting example. Two identical backers were prepared. The backers comprised surface-treated fiber webs that included 100 wt % synthetic fibers. The backers were identical, except that in Sample Backer 1 (SB1) the backer was fluid enhanced to improve its cavity morphology, whereas Control Backer 1 (CB1) included a backer that was not fluid enhanced.

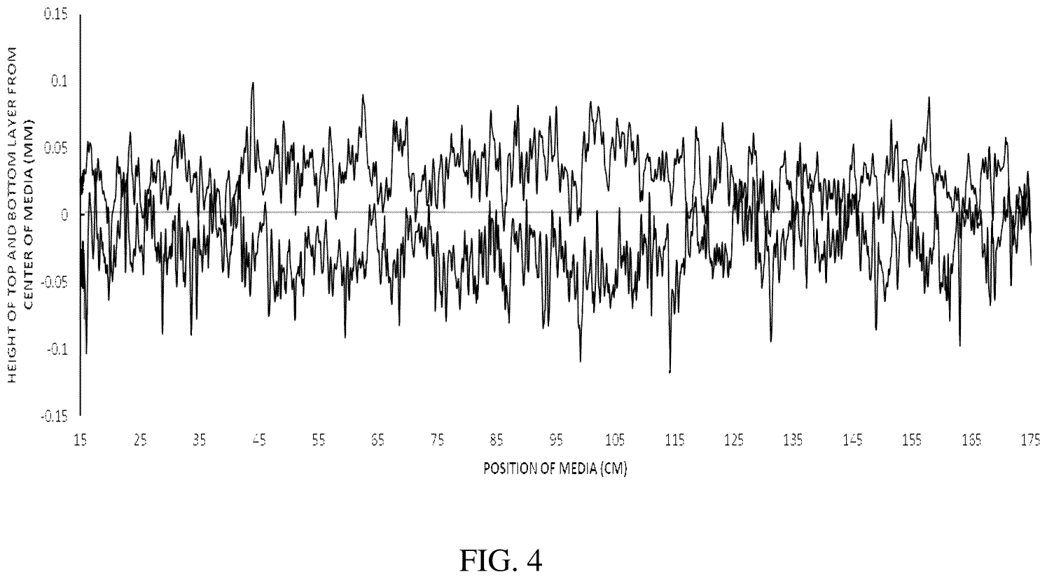

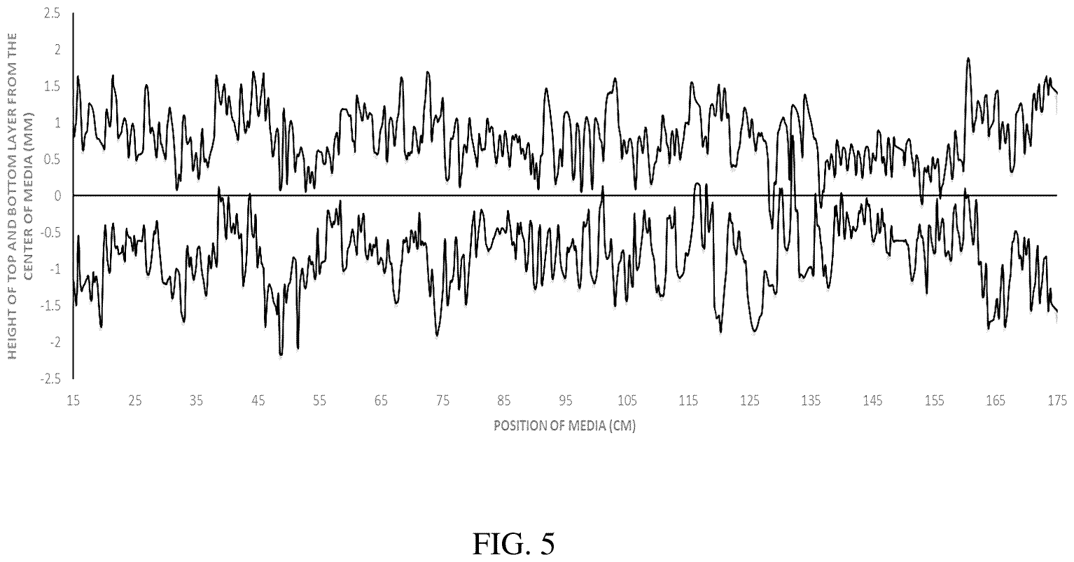

The topography was measured using a Mate Gauge laser system of the type that may be used to determine the cross-dimensional cavity frequency described elsewhere herein. FIG. 4 shows the relative height of the top and bottom of the backer of SB1 over a 175 cm cross-section of the backer. FIG. 5 shows the relative height of the top and bottom portion of the backer of CB1 over a comparable 175 cm cross-section of the backer. As shown, the backer of SB1 included a much higher cross-dimensional cavity frequency (4015 cavities/m), as evidenced by the larger number of peaks present at both the top and the bottom of the backer shown in FIG. 4, relative to the number of peaks observed for the CB1 backer cross-section shown in FIG. 5 (cross-dimensional cavity frequency: 1929 cavities/m). However, visual inspection suggests that the individual cavities of the SB1 backer of FIG. 4 are smaller than the individual cavities of the CB1 backer of FIG. 5. Thus, the improved performance of the backer of SB1 (as reported in Example 1) results both from the increased surface area observed by visual inspection of the SB1 backer of FIG. 4, and from the relatively smaller cavity size, for the reasons discussed above.

### Example 2

This example compares the cavity sizes of the backers SB1 and CB1 described in Example 1. The cavity sizes were measured by processing SEM images of a 1300×1300 micrometer² portion of the surface, measured at a 210× magnification. The SEM images were processed by using Image J to perform a cavity analysis according to a method described above, wherein a threshold of 50 was used. Given the minimum resolution of the image, the properties of a plurality of cavities with areas larger than an assigned minimum cutoff area of 10 micrometers² were analyzed to determine their properties. Table 2 reports the numbers and average areas of different populations of cavities, in order to characterize the size distribution of cavities of SB1 and compare them with the size distribution of cavities of CB1.

TABLE 2

| | | Number | Ave. Cavity | Cavity Area |
|---|---|---|---|---|
| | | of | Area | Coverage |
| Backer | Cavity Size | Cavities | (micrometer²) | (%) |
| CB1 | All Cavities (>10 micrometers²) | 1415 | 360 | 33.1 |
| CB1 | Intermediate and Large (>100 micrometers²) | 794 | 610 | 31.5 |
| CB1 | Large (>1000 micrometers²) | 132 | 1793 | 15.4 |
| SB1 | All Cavities (>10 micrometers²) | 1920 | 147 | 17.9 |
| SB1 | Intermediate and Large (>100 micrometers²) | 776 | 308 | 15.2 |
| SB1 | Large (>1000 micrometers²) | 14 | 1286 | 14.9 |

As shown in Table 2, the backer of SB1 included significantly more cavities than the backer of CB1, but a significantly smaller proportion of the cavities of SB1 were classified as large cavities, and both the average size of large cavities and the average size of intermediate and large cavities together was significantly smaller after fluid enhancement of the backer. This example thus provides further evidence of the morphological improvements to the backer that resulted from fluid enhancement.

### Example 3

This example compares the interfacial area ratio of SB1 and CB1 as described in Example 1). The interfacial area ratio of each backer was determined using the method described above. The SB1 had an interfacial area ratio of 0.710, whereas CB1 had an interfacial area ratio of 0.305. This example thus provides additional evidence of the morphological improvements to the backer that resulted from fluid entanglement.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an.” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B.” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either.” “one of,” “only one of.” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a fiber web comprising a plurality of surface cavities, wherein:
the synthetic fibers of the fiber web have an average length of less than or equal to 40 mm,
the fiber web has a developed interfacial area ratio greater than or equal to 0.1, and
the cavities of the fiber web have an average cross-dimensional frequency of greater than or equal to 3,000 surface cavities per meter; and
a plurality of adsorbent particles disposed on the fiber web.

2. A filter media as in claim 1, wherein the filter media comprises a plurality of adsorbent particles disposed on the nonwoven fiber web.

3. A filter media as in claim 1, wherein the fiber web is non-woven.

4. A filter media according to claim 1, wherein the intermediate and large cavities of the plurality of cavities together have an average area of less than or equal to 500 microns².

5. A filter media according to claim 1, wherein the large cavities of the plurality of cavities have an average area of less than or equal to 1300 microns².

6. A filter media according to claim 1, wherein the matrix polymer comprises only polymers with a molecular weight of greater than 3 kDa.

7. A filter media according to claim 1, wherein the plurality of adsorbent particles is a plurality of carbon particles.

8. A filter media according to claim 1, wherein the adsorbent particles are at least partially disposed within the cavities of the plurality of cavities.

9. A filter media according to claim 1, wherein the fiber web is a first layer of the filter media, and the adsorbent particles form a second layer disposed on top of the first layer.

10. A method of making the filter media of claim 1, comprising first preparing a precursor fiber web and fluid enhancing the precursor fiber web to produce the fiber web of any preceding claim.

11. The method of claim 10, further comprising depositing a layer on the fiber web.

12. A filter media according to claim 1, further comprising an additional layer at least partially disposed on the fiber web.

13. A filter media according to claim 1, wherein the additional layer comprises a fiber web.

14. A filter media according to claim 1, wherein the fiber web of the additional layer comprises a plurality of glass fibers.

15. A filter media according to claim 1, wherein at least some adsorbent particles are disposed within the fiber web.
